(19) United States
(12) Patent Application Publication
(10) Pub. No.: US 2026/0230358 A1
(43) Pub. Date: Aug. 6, 2026

(54) Cyclic Shift Method for Root Sequence and Apparatus

(71) Applicant: HUAWEI TECHNOLOGIES CO., LTD., Shenzhen (CN)

(72) Inventors: Qi Feng, Shanghai (CN); Fan Wang, Shanghai (CN)

(73) Assignee: HUAWEI TECHNOLOGIES CO., LTD., Shenzhen (CN)

(21) Appl. No.: 19/467,347

(22) Filed: Feb. 2, 2026

Related U.S. Application Data
(63) Continuation of application No. PCT/CN2023/111043, filed on Aug. 3, 2023.

(51) Int. Cl. H04L 27/26; H04B 7/185

(52) U.S. Cl. CPC H04L 27/2607; H04B 7/1855

(57) ABSTRACT

A cyclic shift method includes a communication apparatus that determines a cyclic shift of a root sequence, where the cyclic shift of the root sequence is associated with a sequence length of the root sequence, a root sequence number, a maximum round-trip time, and a maximum Doppler frequency shift; and the communication apparatus determines a cyclic shift sequence based on the cyclic shift of the root sequence, where an ambiguity function of the cyclic shift sequence is equal to zero within a range of the maximum round-trip time and the maximum Doppler frequency shift. The communication apparatus can obtain, based on the root sequence, the cyclic shift sequence whose ambiguity function is equal to zero.

### CROSS-REFERENCE TO RELATED APPLICATION

This is a continuation of International Patent Application No. PCT/CN2023/111043 filed on Aug. 3, 2023, which is hereby incorporated by reference in its entirety.

### TECHNICAL FIELD

This disclosure relates to the field of communication technologies, and in particular, to a cyclic shift method for a root sequence and an apparatus.

### BACKGROUND

Communication sequences widely exist in the Long-Term Evolution (LTE)/New Radio (NR) standard protocol. A downlink synchronization signal, uplink random access, and the like may be implemented by using correlation between sequences, and pilot multiplexing may be implemented by using orthogonality between sequences. Common sequence evaluation indicators include: autocorrelation, cross-correlation, sequence capacity, anti-frequency offset, peak-to-average power ratio, dual-domain constant modulus, and the like. How to determine a cyclic shift sequence of a root sequence based on the root sequence is a research direction.

### SUMMARY

This disclosure provides a cyclic shift method for a root sequence and an apparatus, to determine a cyclic shift of the root sequence.

According to a first aspect, a cyclic shift method for a root sequence is provided. The method is performed by a communication apparatus. For example, the communication apparatus may be a terminal, or a chip, a circuit, or the like used in the terminal. Alternatively, the communication apparatus may be an access network device, or a chip, a circuit, or the like used in the access network device. The method includes: determining a cyclic shift of the root sequence, where the cyclic shift of the root sequence is associated with a sequence length of the root sequence, a root sequence number, a maximum round-trip time, round-trip time, and a maximum Doppler frequency shift; and determining a cyclic shift sequence based on the cyclic shift of the root sequence, where an ambiguity function of the cyclic shift sequence is equal to zero within a range of the maximum round-trip time, round-trip time and the maximum Doppler frequency shift.

According to the foregoing design, the communication apparatus may determine a cyclic shift restricted set for resisting any subcarrier spacing frequency offset. For example, a subcarrier spacing frequency offset that needs to be resisted currently, that is, the maximum Doppler frequency shift Δ_{F}, is input into the solution of this disclosure, to obtain a corresponding cyclic shift restricted set, or obtain a corresponding cyclic shift sequence. For example, when there is no need to resist a frequency offset, the maximum Doppler frequency shift is Δ_{F}=1; when a frequency offset of ±1 subcarrier spacings is resisted, the maximum Doppler frequency shift is Δ_{F}=3; when a frequency offset of ±2 subcarrier spacings is resisted, the maximum Doppler frequency shift is Δ_{F}=5; or when a frequency offset of ±f subcarrier spacings is resisted, the maximum Doppler frequency shift is Δ_{F}=2·f+1.

In a design, determining the cyclic shift sequence s_{u,v}(n) based on the cyclic shift Cᵥ of the root sequence satisfies:

$${s}_{u , v} ( n ) = {e}^{- j π u ( n + {C}_{v} ) ( n + {C}_{v} + 1 ) / N}$$

N represents the sequence length of the root sequence, N is a prime number, u represents the root sequence number, a value range of u is 1≤u≤N−1, n represents a symbol index of the cyclic shift sequence, a value range of n is 0≤n≤N−1, and v represents an index of the cyclic shift of the root sequence.

In a design, ambiguity functions A(τ, v) of cyclic shift sequences s_{u,v}_{₁}(n) and s_{u,v}_{₂}(n) are equal to zero within the range of the maximum round-trip time Δ_{T} and the maximum Doppler frequency shift Δ_{F}, and satisfy:

$$A ( τ , v ) = {\sum }_{n = 0}^{N - 1} {s}_{u , {v}_{1}} ( n ) {s}_{u , {v}_{2}}^{*} ( n - τ ) {e}^{j 2 π nv / N} = \{ \begin{matrix}N , & {v}_{1} = {v}_{2} , τ = 0 , v = 0 \\ 0 , & ( {v}_{1} \neq {v}_{2} ) ∨ ( τ \neq 0 ) ∨ ( v \neq 0 )\end{matrix}$$

N represents the sequence length of the root sequence, u represents the root sequence number, v₁ and v₂ represent indexes of cyclic shifts of the root sequence, τ represents a delay coordinate of the ambiguity function, a value range of τ is 0≤τ≤Δ_{T}−1, v represents a Doppler coordinate of the ambiguity function, a value range of v is 0 ST S Δ_{F}−1, an operator (·)* represents a complex conjugate, and an operator V represents conditional OR.

In a design, the cyclic shift Cᵥ of the root sequence satisfies:

$${C}_{v} = ( {τ}_{v} - {u}^{- 1} {v}_{v} ) mod N$$

N represents the sequence length of the root sequence, u represents the root sequence number, v represents the index of the cyclic shift of the root sequence, τᵥ represents a delay-domain cyclic shift, vᵥ represents a Doppler-domain cyclic shift, an operator (·)⁻¹ represents a multiplicative inverse, and v represents the index of the cyclic shift of the root sequence.

In a design, determining the cyclic shift of the root sequence includes: determining a cyclic shift reference point of the root sequence based on a delay-domain cyclic shift reference point and a Doppler-domain cyclic shift reference point; and determining the cyclic shift of the root sequence based on the cyclic shift reference point of the root sequence.

For example, a cyclic shift reference point with a largest quantity of cyclic shifts is selected from the delay-domain cyclic shift reference point and the Doppler-domain cyclic shift reference point as the cyclic shift reference point of the root sequence. The cyclic shift of the root sequence is determined based on the cyclic shift reference point of the root sequence. In the foregoing design, the cyclic shift reference point with the largest quantity of cyclic shifts is used as the cyclic shift reference point of the root sequence, so that a capacity of the determined cyclic shift sequence is maximum.

In a design, the method further includes: determining a delay restricted area in a delay-Doppler coordinate system, where a horizontal axis of the delay-Doppler coordinate system indicates a delay domain, a vertical axis indicates a Doppler domain, the delay restricted area includes one or more peak points of the root sequence, and the peak point is determined based on an ambiguity function of the root sequence; and determining that the peak point of the root sequence included in the delay restricted area is the delay-domain cyclic shift reference point.

In a design, the delay restricted area satisfies: a rectangular area including a start coordinate in the delay domain being Δ_{T}, an end coordinate in the delay domain being min_{v∈{±1, ±2, . . . , ±(Δ}_{_{F}}_{-1)}}{u⁻¹v mod N}, a start coordinate in the Doppler domain being 0, and an end coordinate in the Doppler domain being N−1.

N represents the sequence length of the root sequence, u represents the root sequence number, Δ_{T} represents the maximum round-trip time, Δ_{F} represents the maximum Doppler frequency shift, and an operator (·)⁻¹ represents a multiplicative inverse.

In a design, a set [symbol] including coordinates of the delay-domain cyclic shift reference point satisfies:

$$𝒮\_T {=}^{Δ} \{ 〈 τ\_ 1 \hat{} T , v\_ 1 \hat{} T 〉 , 〈 τ\_ 2 \hat{} T , v\_ 2 \hat{} T 〉 , … , 〈 τ\_ \vert 𝒮\_T \vert \hat{} T , v\_ \vert 𝒮\_T \vert \hat{} T 〉 \} = \{ 〈 τ , u τ mod N 〉 \vert min \{ \pm u τ mod N \} < {min}_{⊤} ( n = 1 , 2 , … , τ - 1 ) \{ \pm un mod N \} , τ ∈ \{ Δ\_T , Δ\_T + 1 , … , {min}_{⊤} ( v ∈ \{ \pm 1 , \pm 2 , … , \pm ( Δ\_F - 1 ) \} ) \{ u \hat{} ( - 1 ) v mod N \} \} \}$$

N represents the sequence length of the root sequence, u represents the root sequence number, Δ_{T} represents the maximum round-trip time, Δ_{F} represents the maximum Doppler frequency shift,

$$〈 {τ}_{i}^{T} , {v}_{i}^{T} 〉$$

represents coordinates or an i^{th} delay-domain cyclic shift reference point, a value range of i is 1≤i≤| [symbol] |, an operator (·)⁻¹ represents a multiplicative inverse, and an operator |·| represents a cardinality of the set.

In a design, the method further includes: determining a Doppler restricted area in the delay-Doppler coordinate system, where the horizontal axis of the delay-Doppler coordinate system indicates the delay domain, the vertical axis indicates the Doppler domain, the Doppler restricted area includes one or more peak points of the root sequence, and the peak point is determined based on the ambiguity function of the root sequence; and determining that the peak point of the root sequence included in the Doppler restricted area is the Doppler-domain cyclic shift reference point.

In a design, the Doppler restricted area satisfies: a rectangular area including a start coordinate in the delay domain being 0, an end coordinate in the delay domain being N−1, a start coordinate in the Doppler domain being Δ_{F}, and an end coordinate in the Doppler domain being min_{τ∈{±1, ±2, . . . , ±(Δ}_{_{T}}_{-1)}}{uτ mod N}.

N represents the sequence length of the root sequence, u represents the root sequence number, Δ_{T} represents the maximum round-trip time, and Δ_{F} represents the maximum Doppler frequency shift. In a design, a set [symbol] including coordinates of the Doppler-domain cyclic shift reference point satisfies:

$$𝒮\_F {=}^{Δ} \{ 〈 τ\_ 1 \hat{} F , v\_ 1 \hat{} F 〉 , 〈 τ\_ 2 \hat{} F , v\_ 2 \hat{} F 〉 , … , 〈 τ\_ \vert 𝒮\_F \vert \hat{} F , v\_ \vert 𝒮\_F \vert \hat{} F 〉 \} = \{ 〈 u \hat{} ( - 1 ) v mod N , v 〉 \vert min \{ \pm u \hat{} ( - 1 ) v mod N \} < {min}_{⊤} ( n = 1 , 2 , … , v - 1 ) \{ \pm u \hat{} ( - 1 ) n mod N \} , v ∈ \{ Δ\_F , Δ\_F + 1 , … , {min}_{⊤} ( τ ∈ \{ \pm 1 , \pm 2 , … , \pm ( Δ\_T - 1 ) \} ) \{ u τ mod N \} \} \}$$

N represents the sequence length of the root sequence, u represents the root sequence number, Δ_{T} represents the maximum round-trip time, Δ_{F} represents the maximum Doppler frequency shift,

$$〈 {τ}_{i}^{F} , {v}_{i}^{F} 〉$$

represents an i^{th} Doppler-domain cyclic shift reference point, a value range of i is 1≤i≤| [symbol] |, an operator (·)⁻¹ represents a multiplicative inverse, and an operator |·| represents a cardinality of the set.

In a design, a quantity

$${Ω}_{★}^{†}$$

of cyclic shifts corresponding to the cyclic shift reference point

$$〈 {τ}_{★}^{†} , {v}_{★}^{†} 〉$$

of the root sequence satisfies:

$${Ω}_{★}^{†} = max \{ {Ω}_{1}^{T} , {Ω}_{2}^{T} , … {Ω}_{\vert {𝒮}_{T} \vert}^{T} , {Ω}_{1}^{F} , {Ω}_{2}^{F} , … , {Ω}_{\vert {𝒮}_{F} \vert}^{F} \}$$

$${Ω}_{1}^{T} , {Ω}_{2}^{T} , … {Ω}_{\vert {𝒮}_{T} \vert}^{T}$$

represents a quantity of cyclic shifts corresponding to the delay-domain cyclic shift reference point,

$${Ω}_{1}^{F} , {Ω}_{2}^{F} , … , {Ω}_{\vert {𝒮}_{F} \vert}^{F}$$

represents a quantity of cyclic shifts corresponding to the Doppler-domain cyclic shift reference point, and

$${Ω}_{★}^{†}$$

represents the quantity of cyclic shifts corresponding to the cyclic shift reference point of the root sequence.

In a design, a quantity

$${Ω}_{i}^{T}$$

of cyclic shifts corresponding to the delay-domain cyclic shift reference point satisfies:

$${Ω}_{i}^{T} = {k}_{i}^{T} \cdot {l}_{i}^{T} + {\overline{k}}_{i}^{T} \cdot {\overline{l}}_{i}^{T} + {\overline{\overline{k}}}_{i}^{T} \cdot {\overline{\overline{l}}}_{i}^{T}$$

$${k}_{i}^{T}$$

represents a quantity of delay-domain complete cyclic shifts,

$${l}_{i}^{T}$$

represents a quantity of Doppler-domain complete cyclic shifts,

$${\overline{k}}_{i}^{T}$$

represents a quantity or delay-domain near-end residual cyclic shifts,

$${\overline{l}}_{i}^{T}$$

represents a quantity of Doppler-domain near-end residual cyclic shifts,

$${\overline{\overline{k}}}_{i}^{T}$$

represents a quantity of delay-domain far-end residual cyclic shifts,

$${\overline{\overline{l}}}_{i}^{T}$$

represents a quantity of Doppler-domain far-end residual cyclic shifts, and a value range of i is 1≤i≤| [symbol] |.

In a design, the quantity

$${k}_{i}^{T}$$

of delay-domain complete cyclic shifts satisfies:

$${k}_{i}^{T} = ⌊ {τ}_{i}^{T} / {Δ}_{T} ⌋$$

Δ_{T} represents the maximum round-trip time,

$$〈 {τ}_{i}^{T} , {v}_{i}^{T} 〉$$

represents the coordinates of the delay-domain cyclic shift reference point, and an operator └·┘ represents rounding down.

The quantity

$${l}_{i}^{T}$$

of Doppler-domain complete cyclic shifts satisfies:

Restriction coordinates

$$〈 {\overline{τ}}_{i}^{T} , {\overline{v}}_{i}^{T} 〉$$

are determined based on the coordinates

$$〈 {τ}_{i}^{T} , {v}_{i}^{T} 〉$$

of the delay-domain cyclic shift reference point, and satisfy:

$$\{ \begin{matrix}{\overline{τ}}_{i}^{T} = {min}_{v ∈ \{ 1 , 2 , … , max \{ {Δ}_{F} - 1 , min \{ {v}_{i}^{T} , N - {v}_{i}^{T} \} - 1 \} \}} \{ sgn ( {v}_{i}^{T} - N / 2 ) {u}^{- 1} v mod N \} \\ {\overline{v}}_{i}^{T} = u {\overline{τ}}_{i}^{T} mod N\end{matrix}$$

N represents the sequence length of the root sequence, u represents the root sequence number, Δ_{F} represents the maximum Doppler frequency shift, and an operator (·)⁻¹ represents a multiplicative inverse.

A Doppler spacing

$${d}_{i}^{T}$$

is determined based on the coordinates

$$〈 {τ}_{i}^{T} , {v}_{i}^{T} 〉$$

of the delay-domain cyclic shift reference point and the restriction coordinates

$$〈 {\overline{τ}}_{i}^{T} , {\overline{v}}_{i}^{T} 〉 ,$$

and satisfies

$${d}_{i}^{T} = min \{ d \vert {τ}_{i}^{T} - ( ⌊ \frac{d / {Δ}_{F}}{⌈ min \{ {v}_{i}^{T} , N - {v}_{i}^{T} \} / {Δ}_{F} ⌉} ⌋ + 1 ) \cdot {τ}_{i}^{T} mod {Δ}_{T} \geq {\overline{τ}}_{i}^{T} - ⌊ \frac{d - min \{ {\overline{v}}_{i}^{T} , N - {\overline{v}}_{i}^{T} \}}{min \{ {v}_{i}^{T} , N - {v}_{i}^{T} \}} ⌋ \cdot {τ}_{i}^{T} \}$$

N represents the sequence length of the root sequence, Δ_{T} represents the maximum round-trip time, Δ_{F} represents the maximum Doppler frequency shift, an operator └·┘ represents rounding down, and an operator ┌·┐ represents rounding up.

The quantity

$${l}_{i}^{T}$$

of Doppler-domain complete cyclic shifts is determined based on the Doppler spacing

$${d}_{i}^{T} ,$$

and satisfies:

$${l}_{i}^{T} = ⌊ {d}_{i}^{T} / {Δ}_{F} ⌋$$

Δ_{F} represents the maximum Doppler frequency shift,

$${d}_{i}^{T}$$

represents the Doppler spacing, and an operator └·┘ represents rounding down.

The quantity

$${\overline{k}}_{i}^{T}$$

of delay-domain near-end residual cyclic shifts satisfies:

$${\overline{k}}_{i}^{T} = max \{ ⌊ ( {\overline{τ}}_{i}^{T} - ⌊ \frac{{d}_{i}^{T} - min \{ {\overline{v}}_{i}^{T} , N - {\overline{v}}_{i}^{T} \}}{min \{ {v}_{i}^{T} , N - {v}_{i}^{T} \}} ⌋ \cdot {τ}_{i}^{T} + ( ⌊ \frac{{l}_{i}^{T} - 1}{⌈ min \{ {v}_{i}^{T} , N - {v}_{i}^{T} \} / {Δ}_{F} ⌉} ⌋ + 1 ) \cdot {τ}_{i}^{T} mod {Δ}_{T} ) / {Δ}_{T} ⌋ , 0 \}$$

N represents the sequence length of the root sequence, Δ_{T} represents the maximum round-trip time, Δ_{F} represents the maximum Doppler frequency shift,

$$〈 {τ}_{i}^{T} , {v}_{i}^{T} 〉$$

represents the coordinates of the delay-domain cyclic shift reference point,

$$〈 {\overline{τ}}_{i}^{T} , {\overline{v}}_{i}^{T} 〉$$

represents the restriction
coordinates

$${l}_{i}^{T}$$

represents the quantity of Doppler-domain complete cyclic shifts, an operator └·┘ represents rounding down, and an operator ┌·┐ represents rounding up.

The quantity

$${\overline{l}}_{i}^{T}$$

of Doppler-domain near-end residual cyclic shifts satisfies:

$${\overline{l}}_{i}^{T} = {l}_{i}^{T} - ⌈ min \{ {v}_{i}^{T} , N - {v}_{i}^{T} \} / {Δ}_{F} ⌉ \cdot ⌊ \frac{{l}_{i}^{T}}{⌈ min \{ {v}_{i}^{T} , N - {v}_{i}^{T} \} / {Δ}_{F} ⌉} ⌋$$

N represents the sequence length of the root sequence, Δ_{F} represents the maximum Doppler frequency shift,

$$〈 {τ}_{i}^{T} , {v}_{i}^{T} 〉$$

represents the coordinates of the delay-domain cyclic shift reference point,

$${l}_{i}^{T}$$

represents the quantity of Doppler-domain complete cyclic shifts, an operator └·┘ represents rounding down, and an operator ┌·┐ represents rounding up.

The quantity

$${{k}^{=}}_{i}^{T}$$

of delay-domain far-end residual cyclic shifts satisfies:

$${{k}^{=}}_{i}^{T} = max \{ ⌊ ( {\overline{τ}}_{i}^{T} - ⌊ \frac{{d}_{i}^{T} - min \{ {\overline{v}}_{i}^{T} , N - {\overline{v}}_{i}^{T} \}}{min \{ {v}_{i}^{T} , N - {v}_{i}^{T} \}} ⌋ \cdot {τ}_{i}^{T} + ( ⌊ \frac{2 {l}_{i}^{T} - ⌊ ( {d}_{i}^{T} + min \{ {v}_{i}^{T} , N - {v}_{i}^{T} \} ) / {Δ}_{F} ⌋}{⌈ min \{ {v}_{i}^{T} , N - {v}_{i}^{T} \} / {Δ}_{F} ⌉} ⌋ + 1 ) \cdot {τ}_{i}^{T} mod {Δ}_{T} ) / {Δ}_{T} ⌋ , 0 \}$$

N represents the sequence length of the root sequence, Δ_{T} represents the maximum round-trip time, Δ_{F} represents the maximum Doppler frequency shift,

$$〈 {τ}_{i}^{T} , {v}_{i}^{T} 〉$$

represents the coordinates of the delay-domain cyclic shift reference point

$$〈 {\overline{τ}}_{i}^{T} , {\overline{v}}_{i}^{T} 〉$$

represents the restriction coordinates,

$${l}_{i}^{T}$$

represents the quantity of Doppler-domain complete cyclic shifts, an operator └·┘ represents rounding down, and an operator ┌·┐ represents rounding up.

The quantity

$${{l}^{=}}_{i}^{F}$$

of Doppler-domain far-end residual cyclic shifts satisfies:

$${{l}^{=}}_{i}^{T} = ⌊ ( {d}_{i}^{T} + min \{ {v}_{i}^{T} , N - {v}_{i}^{T} \} ) / {Δ}_{F} ⌋ - {l}_{i}^{T} - {\overline{l}}_{i}^{T}$$

N represents the sequence length of the root sequence, Δ_{F} represents the maximum Doppler frequency shift,

$$〈 {τ}_{i}^{T} , {v}_{i}^{T} 〉$$

represents the coordinates of the delay-domain cyclic shift reference point,

$${l}_{i}^{T}$$

represents the quantity of Doppler-domain complete cyclic shifts,

$${\overline{l}}_{i}^{T}$$

represents the quantity of Doppler-domain near-end residual cyclic shifts, and an operator ┌·┐ represents rounding up.

In a design, a quantity

$${Ω}_{i}^{F}$$

of cyclic shifts corresponding to the Doppler-domain cyclic shift reference point satisfies:

$${Ω}_{i}^{F} = {l}_{i}^{F} \cdot {k}_{i}^{F} + {\overline{l}}_{i}^{F} \cdot {\overline{k}}_{i}^{F} + {{l}^{=}}_{i}^{F} \cdot {{k}^{=}}_{i}^{F} {l}_{i}^{F}$$

represents a quantity of Doppler-domain complete cyclic shows,

$${k}_{i}^{F}$$

represents a quantity of delay-domain complete cyclic shifts

$${\overline{l}}_{i}^{F}$$

represents a quantity of Doppler-domain near-end residual cyclic shifts,

$${\overline{k}}_{i}^{F}$$

represents a quantity or delay-domain near-end residual cyclic shifts,

$${{l}^{=}}_{i}^{F}$$

represents a quantity of Doppler-domain far-end residual cyclic shifts,

$${{k}^{=}}_{i}^{F}$$

represents a quantity of delay-domain far-end residual cyclic shifts, and a value range of i is 1≤i≤| [symbol] |.

In a design, the quantity

$${l}_{i}^{F}$$

of Doppler-domain complete cyclic shifts satisfies:

$${l}_{i}^{F} = ⌊ {v}_{i}^{F} / {Δ}_{F} ⌋$$

Δ_{F} represents the maximum Doppler frequency shift,

$$〈 {τ}_{i}^{F} , {v}_{i}^{F} 〉$$

represents the coordinates of the Doppler-domain cyclic shift reference point, and an operator └·┘ represents rounding down.

The quantity

$${k}_{i}^{F}$$

of delay-domain complete cyclic shifts satisfies:

Restriction coordinates

$$〈 {\overline{τ}}_{i}^{F} , {\overline{v}}_{i}^{F} 〉$$

are determined based on the coordinates

$$〈 {τ}_{i}^{F} , {v}_{i}^{F} 〉$$

of the Doppler-domain cyclic shift reference point, and satisfy:

$$\{ \text{} \begin{matrix}{\overline{v}}_{i}^{F} = {min}_{τ ∈ \{ 1 , 2 , … , max \{ {Δ}_{T} - 1 , min \{ {τ}_{i}^{F} , N - {τ}_{i}^{F} \} - 1 \} \}} \{ sgn ( {τ}_{i}^{F} - N / 2 ) u τ mod N \} \\ {\overline{τ}}_{i}^{F} = {u}^{- 1} {\overline{v}}_{i}^{F} mod N\end{matrix} \text{}$$

N represents the sequence length of the root sequence, u represents the root sequence number, Δ_{T} represents the maximum round-trip time

$$〈 {τ}_{i}^{F} , {v}_{i}^{F} 〉$$

represents the coordinates of the Doppler-domain cyclic shift reference point, and an operator (·)⁻¹ represents a multiplicative inverse.

A delay spacing

$${d}_{i}^{F}$$

is determined based on the coordinates

$$〈 {τ}_{i}^{F} , {v}_{i}^{F} 〉$$

of the Doppler-domain cyclic shift reference point and the restriction coordinates

$$〈 {\overline{τ}}_{i}^{F} , {\overline{v}}_{i}^{F} \text{〉:}$$

$${d}_{i}^{F} = min \{ d \vert {v}_{i}^{F} - ( ⌊ \frac{d / {Δ}_{T}}{⌈ min \{ {τ}_{i}^{F} , N - {τ}_{i}^{F} \} / {Δ}_{T}} ⌋ + 1 ) \cdot {v}_{i}^{F} mod {Δ}_{F} \geq {\overline{v}}_{i}^{F} - ⌊ \frac{d - min \{ {\overline{τ}}_{i}^{F} , N - {\overline{τ}}_{i}^{F} \}}{min \{ {τ}_{i}^{F} , N - {τ}_{i}^{F} \}} ⌋ \cdot {v}_{i}^{F} \}$$

N represents the sequence length of the root sequence, Δ_{T} represents the maximum round-trip time, Δ_{F} represents the maximum Doppler frequency shift,

$$〈 {τ}_{i}^{F} , {v}_{i}^{F} 〉$$

represents the coordinates of the Doppler-domain cyclic shift reference point,

$$〈 {\overline{τ}}_{i}^{F} , {\overline{v}}_{i}^{F} 〉$$

represents the restriction coordinates, an operator └·┘ represents rounding down, and an operator ┌·┐ represents rounding up.

The quantity

$${k}_{i}^{F}$$

of delay-domain complete cyclic shifts is determined based on the delay spacing

$${d}_{i}^{F}$$

and satisfies:

$${k}_{i}^{F} = ⌊ {d}_{i}^{F} / {Δ}_{T} ⌋$$

Δ_{T} represents the maximum round-trip time,

$${d}_{i}^{F}$$

represents the delay spacing, and an operator └·┘ represents rounding down.

The quantity

$${\overline{l}}_{i}^{F}$$

of Doppler-domain near-end residual cyclic shifts satisfies:

$${\overline{l}}_{i}^{F} = max \{ ⌊ ( {\overline{v}}_{i}^{F} - ⌊ \frac{{d}_{i}^{F} - min \{ {\overline{τ}}_{i}^{F} , N - {\overline{τ}}_{i}^{F} \}}{min \{ {τ}_{i}^{F} , N - {τ}_{i}^{F} \}} ⌋ \cdot {v}_{i}^{F} + ( ⌊ \frac{{k}_{i}^{F} - 1}{⌈ min \{ {τ}_{i}^{F} , N - {τ}_{i}^{F} \} / {Δ}_{T} ⌉} ⌋ + 1 ) \cdot {v}_{i}^{F} mod {Δ}_{F} ⌋ , 0 \}$$

N represents the sequence length of the root sequence, Δ_{T} represents the maximum round-trip time, Δ_{F} represents the maximum Doppler frequency shift,

$$〈 {τ}_{i}^{F} , {v}_{i}^{F} 〉$$

represents the coordinates of the Doppler-domain cyclic shift reference point,

$$〈 {\overline{τ}}_{i}^{T} , {\overline{v}}_{i}^{T} 〉$$

represents the restriction coordinates,

$${k}_{i}^{F}$$

represents the quantity or delay-domain complete cyclic shifts, an operator └·┘ represents rounding down, and an operator ┌·┐ represents rounding up.

The quantity

$${\overline{k}}_{i}^{F}$$

of delay-domain near-end residual cyclic shifts satisfies:

$${\overline{k}}_{i}^{F} = {k}_{i}^{F} - ⌈ min \{ {τ}_{i}^{F} , N - {τ}_{i}^{F} \} / {Δ}_{T} ⌉ \cdot ⌊ \frac{{k}_{i}^{F}}{⌈ min \{ {τ}_{i}^{F} , N - {τ}_{i}^{F} \} / {Δ}_{T} ⌉} ⌋$$

N represents the sequence length of the root sequence, Δ_{T} represents the maximum round-trip time,

$$〈 {τ}_{i}^{F} , {v}_{i}^{F} 〉$$

represents of the coordinates of the Doppler-domain cyclic shift reference point,

$${k}_{i}^{F}$$

represents the quantity of delay-domain complete cyclic shifts, an operator └·┘ represents rounding down, and an operator ┌·┐ represents rounding up.

The quantity

$${{l}^{=}}_{i}^{F}$$

of Doppler-domain far-end residual cyclic shifts satisfies:

$${{l}^{=}}_{i}^{F} = max \{ ⌊ ( {\overline{v}}_{i}^{F} - ⌊ \frac{{d}_{i}^{F} - min \{ {\overline{τ}}_{i}^{F} , N - {\overline{τ}}_{i}^{F} \}}{min \{ {τ}_{i}^{F} , N - {τ}_{i}^{F} \}} ⌋ \cdot {v}_{i}^{F} + ( ⌊ \frac{2 {k}_{i}^{F} - ⌊ ( {d}_{i}^{F} + min \{ {τ}_{i}^{F} , N - {τ}_{i}^{F} \} ) / {Δ}_{T} ⌋}{⌈ min \{ {τ}_{i}^{F} , N - {τ}_{i}^{F} \} / {Δ}_{T} ⌉} ⌋ + 1 ) \cdot {v}_{i}^{F} mod {Δ}_{F} ) / {Δ}_{F} ⌋ , 0 \}$$

N represents the sequence length of the root sequence, Δ_{T} represents the maximum round-trip time, Δ_{F} represents the maximum Doppler frequency shift,

$$〈 {τ}_{i}^{F} , {v}_{i}^{F} 〉$$

represents the coordinates of the Doppler-domain cyclic shift reference point,

$$〈 {\overline{τ}}_{i}^{F} , {\overline{v}}_{i}^{F} 〉$$

represents the restriction coordinates,

$${k}_{i}^{F}$$

represents the quantity of delay-domain complete cyclic shifts, an operator └·┘ represents rounding down, and an operator ┌·┐ represents rounding up.

The quantity

$${{k}^{=}}_{i}^{F}$$

of delay-domain far-end residual cyclic shifts satisfies:

$${\overline{\overline{k}}}_{i}^{F} = ⌊ ( {d}_{i}^{F} + min \{ {τ}_{i}^{F} , N - {τ}_{i}^{F} \} ) / {Δ}_{T} ⌋ - {k}_{i}^{F} - {\overline{k}}_{i}^{F}$$

N represents the sequence length of the root sequence, Δ_{T} represents the maximum round-trip time,

$$〈 {τ}_{i}^{F} , {v}_{i}^{F} 〉$$

represents the coordinates of the Doppler-domain cyclic shift reference point,

$${k}_{i}^{F}$$

represents the quantity or delay-domain complete cyclic shins, represents

$${\overline{k}}_{i}^{F}$$

represents the quantity of delay-domain near-end residual cyclic shifts, and an operator └·┘ represents rounding down.

In a design, determining the cyclic shift of the root sequence includes: determining the delay-domain cyclic shift τᵥ and the Doppler-domain cyclic shift vᵥ based on the quantity of delay-domain complete cyclic shifts and the quantity of Doppler-domain complete cyclic shifts that correspond to the cyclic shift reference point of the root sequence; and determining the cyclic shift Cᵥ of the root sequence based on the delay-domain cyclic shift τᵥ and the Doppler-domain cyclic shift vᵥ.

v represents the index of the cyclic shift of the root sequence, and a value range of v is

$$0 \leq v \leq {Ω}_{★}^{†} - 1 .$$

In a design, the cyclic shift reference point of the root sequence is the delay-domain cyclic shift reference point, and the delay-domain cyclic shift

$${τ}_{{k}_{★}^{T} \cdot l + k}$$

and the Doppler-domain cyclic shift

$${v}_{{k}_{★}^{T} \cdot l + k}$$

satisfy:

$$\{ \begin{matrix}{τ}_{{k}_{★}^{T} \cdot l + k} = k {Δ}_{T} - ⌊ \frac{l}{⌈ min \{ {v}_{★}^{T} , N - {v}_{★}^{T} \} / {Δ}_{F} ⌉} ⌋ \cdot {τ}_{★}^{T} mod {Δ}_{T} \\ {v}_{{k}_{★}^{T} \cdot l + k} = sgn ( {v}_{★}^{T} - N / 2 ) \cdot l {Δ}_{F}\end{matrix}$$

where N represents the sequence length of the root sequence, Δ_{T} represents the maximum round-trip time, Δ_{F} represents the maximum Doppler frequency shift,

$$〈 {τ}_{★}^{T} , {v}_{★}^{T} 〉$$

represents coordinates of the cyclic shift reference point of the root sequence,

$${k}_{★}^{T}$$

represents the quantity of delay-domain complete cyclic shifts,

$${l}_{★}^{T}$$

represents the quantity of Doppler-domain complete cyclic shifts, value ranges of k and l are

$$\{ 0 \leq k < {k}_{★}^{T} , 0 \leq l < {l}_{★}^{T} \} ,$$

an operator sgn(·) represents a sign function, an operator └·┘ represents rounding down, and an operator ┌·┐ represents rounding up; and/or the cyclic shift reference point of the root sequence is the Doppler-domain cyclic shift reference point, and the delay-domain cyclic shift

$${τ}_{{l}_{★}^{F} \cdot k + l}$$

and the Doppler-domain cyclic shift

$${v}_{{l}_{★}^{F} \cdot k + l}$$

satisfy:

$$\{ \begin{matrix}{τ}_{{l}_{★}^{F} \cdot k + l} = sgn ( {τ}_{★}^{F} - N / 2 ) \cdot k {Δ}_{T} \\ {v}_{{l}_{★}^{F} \cdot k + l} = l {Δ}_{F} - ⌊ \frac{k}{⌈ min \{ {τ}_{★}^{F} , N - {τ}_{★}^{F} \} / {Δ}_{T} ⌉} ⌋ \cdot {v}_{★}^{F} mod {Δ}_{F}\end{matrix}$$

where N represents the sequence length of the root sequence, Δ_{T} represents the maximum round-trip time, Δ_{F} represents the maximum Doppler frequency shift,

$$〈 {τ}_{★}^{F} , {v}_{★}^{F} 〉$$

represents coordinates of the cyclic shift reference point of the root sequence,

$${l}_{★}^{F}$$

represents the quantity of Doppler-domain complete cyclic shifts,

$${k}_{★}^{F}$$

represents the quantity of delay-domain complete cyclic shifts, value ranges of k and l are

$$\{ 0 \leq k < {k}_{★}^{F} , 0 \leq l < {l}_{★}^{F} \} ,$$

an operator sgn(·) represents a sign function, an operator └·┘ represents rounding down, and an operator ┌·┐ represents rounding up.

In a design, determining the cyclic shift of the root sequence includes: determining the delay-domain cyclic shift τᵥ and the Doppler-domain cyclic shift vᵥ based on the quantity of delay-domain complete cyclic shifts, the quantity of Doppler-domain complete cyclic shifts, the quantity of delay-domain near-end residual cyclic shifts, and the quantity of Doppler-domain near-end residual cyclic shifts that correspond to the cyclic shift reference point of the root sequence; and determining the cyclic shift Cᵥ of the root sequence based on the delay-domain cyclic shift τᵥ and the Doppler-domain cyclic shift vᵥ.

v represents the index of the cyclic shift of the root sequence, and a value range of v is

$$0 \leq v \leq {Ω}_{★}^{†} - 1 .$$

In a design, the cyclic shift reference point of the root sequence is the delay-domain cyclic shift reference point, and the delay-domain cyclic shift

$${τ}_{{k}_{★}^{T} \cdot {l}_{★}^{T} + {\overline{k}}_{★}^{T} \cdot ( {\overline{l}}_{★}^{T} + l ) + {\overline{k}}_{★}^{T} - k}$$

and the Doppler-domain cyclic shift

$${v}_{{k}_{★}^{T} \cdot {l}_{★}^{T} + {\overline{k}}_{★}^{T} \cdot ( {\overline{l}}_{★}^{T} + l ) + {\overline{k}}_{★}^{T} - k}$$

satisfy:

$$\{ \begin{matrix}{τ}_{{k}_{★}^{T} \cdot {l}_{★}^{T} + {\overline{k}}_{★}^{T} \cdot ( {\overline{l}}_{★}^{T} + l ) + {\overline{k}}_{★}^{T} - k} & = {τ}_{★}^{T} - k {Δ}_{T} \\ {v}_{{k}_{★}^{T} \cdot {l}_{★}^{T} + {\overline{k}}_{★}^{T} \cdot ( {\overline{l}}_{★}^{T} + l ) + {\overline{k}}_{★}^{T} - k} & = sgn ( {v}_{★}^{T} - N / 2 ) \cdot l {Δ}_{F}\end{matrix}$$

where N represents the sequence length of the root sequence, Δ_{T} represents the maximum round-trip time, Δ_{F} represents the maximum Doppler frequency shift,

$$〈 {τ}_{★}^{T} , {v}_{★}^{T} 〉$$

represents coordinates of the cyclic shift reference point of the root sequence,

$${k}_{★}^{T}$$

represents the quantity of delay-domain complete cyclic shifts,

$${l}_{★}^{T}$$

represents the quantity of Doppler-domain complete cyclic shifts,

$${\overline{k}}_{★}^{T}$$

represents the quantity of delay-domain near-end residual cyclic shifts,

$${\overline{l}}_{★}^{T}$$

represents the quantity of Doppler-domain near-end residual cyclic shifts, value ranges of k and l are

$$\{ 0 < k \leq {\overline{k}}_{★}^{T} , - {\overline{l}}_{★}^{T} \leq l < 0 \} ,$$

and an operator sgn(·) represents a sign function; and/or the cyclic shift reference point of the root sequence is the Doppler-domain cyclic shift reference point, and the delay-domain cyclic shift

$${τ}_{{l}_{★}^{F} \cdot {k}_{★}^{F} + {\overline{l}}_{★}^{F} \cdot ( {\overline{k}}_{★}^{F} + k ) + {\overline{l}}_{★}^{F} - l}$$

and the Doppler-domain cyclic shift

$${v}_{{l}_{★}^{F} \cdot {k}_{★}^{F} + {\overline{l}}_{★}^{F} \cdot ( {\overline{k}}_{★}^{F} + k ) + {\overline{l}}_{★}^{F} - l}$$

satisfy:

$$\{ \begin{matrix}{τ}_{{l}_{★}^{F} \cdot {k}_{★}^{F} + {\overline{l}}_{★}^{F} \cdot ( {\overline{k}}_{★}^{F} + k ) + {\overline{l}}_{★}^{F} - l} & = sgn ( {τ}_{★}^{F} - N / 2 ) \cdot k {Δ}_{T} \\ {v}_{{l}_{★}^{F} \cdot {k}_{★}^{F} + {\overline{l}}_{★}^{F} \cdot ( {\overline{k}}_{★}^{F} + k ) + {\overline{l}}_{★}^{F} - l} & = {v}_{★}^{F} - l {Δ}_{F}\end{matrix}$$

where N represents the sequence length of the root sequence, Δ_{T} represents the maximum round-trip time, Δ_{F} represents the maximum Doppler frequency shift,

$$〈 {τ}_{★}^{F} , {v}_{★}^{F} 〉$$

represents coordinates of the cyclic shift reference point of the root sequence,

$${l}_{★}^{F}$$

represents the quantity of Doppler-domain complete cyclic shifts,

$${k}_{★}^{F}$$

represents the quantity of delay-domain complete cyclic shifts,

$${\overline{l}}_{★}^{F}$$

represents the quantity of Doppler-domain near-end residual cyclic shifts,

$${\overline{k}}_{★}^{F}$$

represents the quantity of delay-domain near-end residual cyclic shifts, value ranges of k and l are

$$\{ - {\overline{k}}_{★}^{F} \leq k < 0 , 0 < l \leq {l}_{★}^{F} \} ,$$

and an operator sgn(·) represents a sign function.

In a design, determining the cyclic shift of the root sequence includes: determining the delay-domain cyclic shift τᵥ and the Doppler-domain cyclic shift vᵥ based on the quantity of delay-domain complete cyclic shifts, the quantity of Doppler-domain complete cyclic shifts, the quantity of delay-domain near-end residual cyclic shifts, the quantity of Doppler-domain near-end residual cyclic shifts, the quantity of delay-domain far-end residual cyclic shifts, and the quantity of Doppler-domain far-end residual cyclic shifts that correspond to the cyclic shift reference point of the root sequence; and determining the cyclic shift Cᵥ of the root sequence based on the delay-domain cyclic shift τᵥ and the Doppler-domain cyclic shift vᵥ. v represents the index of the cyclic shift of the root sequence, and a value range of v is

$$0 \leq v \leq {Ω}_{★}^{†} - 1 .$$

In a design, the cyclic shift reference point of the root sequence is the delay-domain cyclic shift reference point, and the delay-domain cyclic shift

$${τ}_{{k}_{★}^{T} \cdot {l}_{★}^{T} + {\overline{k}}_{★}^{T} \cdot {\overline{l}}_{★}^{T} + {{k}^{=}}_{★}^{T} \cdot ( {\overline{l}}_{★}^{T} + {{l}^{=}}_{★}^{T} + l ) + {{k}^{=}}_{★}^{T} - k}$$

and the Doppler-domain cyclic shift

$${v}_{{k}_{★}^{T} \cdot {l}_{★}^{T} + {\overline{k}}_{★}^{T} \cdot {\overline{l}}_{★}^{T} + {{k}^{=}}_{★}^{T} \cdot ( {\overline{l}}_{★}^{T} + {{l}^{=}}_{★}^{T} + l ) + {{k}^{=}}_{★}^{T} - k}$$

satisfy

$$\{ \begin{matrix}{τ}_{{k}_{★}^{T} \cdot {l}_{★}^{T} + {\overline{k}}_{★}^{T} \cdot {\overline{l}}_{★}^{T} + {{k}^{=}}_{★}^{T} \cdot ( {\overline{l}}_{★}^{T} + {{l}^{=}}_{★}^{T} + l ) + {{k}^{=}}_{★}^{T} - k} & = {τ}_{★}^{T} - l {Δ}_{T} \\ {v}_{{k}_{★}^{T} \cdot {l}_{★}^{T} + {\overline{k}}_{★}^{T} \cdot {\overline{l}}_{★}^{T} + {{k}^{=}}_{★}^{T} \cdot ( {\overline{l}}_{★}^{T} + {{l}^{=}}_{★}^{T} + l ) + {{k}^{=}}_{★}^{T} - k} & = sgn ( {v}_{★}^{T} - N / 2 ) \cdot l {Δ}_{F}\end{matrix}$$

where N represents the sequence length of the root sequence, Δ_{T} represents the maximum round-trip time, Δ_{F} represents the maximum Doppler frequency shift,

$$〈 {τ}_{★}^{T} , {v}_{★}^{T} 〉$$

represents coordinates of the cyclic shift reference point of the root sequence,

$${k}_{★}^{T}$$

represents the quantity of delay-domain complete cyclic shifts,

$${l}_{★}^{T}$$

represents the quantity of Doppler-domain complete cyclic shifts,

$${\overline{k}}_{⋆}^{T}$$

represents the quantity of delay-domain near-end residual cyclic shifts,

$${\overline{l}}_{*}^{T}$$

represents the quantity of delay-domain near-end residual cycle shifts,

$${{k}^{=}}_{⋆}^{T}$$

represents the quantity of delay-domain far-end residual cyclic shifts,

$${{l}^{=}}_{*}^{T}$$

represents the quality of Doppler-domain far-end residual cyclic shifts, value ranges of k and l are

$$\{ 0 < k \leq {{k}^{=}}_{⋆}^{T} , - {\overline{l}}_{*}^{T} - {{l}^{=}}_{*}^{T} \leq l < - {\overline{l}}_{*}^{T} \} ,$$

and an operator sgn(·) represents a sign function; and/or the cyclic shift reference point of the root sequence is the Doppler-domain cyclic shift reference point, and the delay-domain cyclic shift

$${τ}_{{l}_{*}^{F} \cdot {k}_{*}^{F} + {\overline{l}}_{*}^{F} \cdot {\overline{k}}_{*}^{F} + {{l}^{=}}_{*}^{F} \cdot ( {\overline{k}}_{*}^{F} + {{k}^{=}}_{*}^{F} + k ) + {{l}^{=}}_{*}^{F} - l}$$

and the Doppler-domain cyclic shift

$${v}_{{l}_{*}^{F} \cdot {k}_{*}^{F} + {\overline{l}}_{*}^{F} \cdot {\overline{k}}_{*}^{F} + {{l}^{=}}_{*}^{F} \cdot ( {\overline{k}}_{*}^{F} + {{k}^{=}}_{*}^{F} + k ) + {{l}^{=}}_{*}^{F} - l}$$

satisfy:

$$\{ \begin{matrix}{τ}_{{l}_{*}^{F} \cdot {k}_{*}^{F} + {\overline{l}}_{*}^{F} \cdot {\overline{k}}_{*}^{F} + {{l}^{=}}_{*}^{F} \cdot ( {\overline{k}}_{*}^{F} + {{k}^{=}}_{*}^{F} + k ) + {{l}^{=}}_{*}^{F} - l} = sgn ( {τ}_{*}^{F} - N / 2 ) \cdot k {Δ}_{T} \\ {v}_{{l}_{*}^{F} \cdot {k}_{*}^{F} + {\overline{l}}_{*}^{F} \cdot {\overline{k}}_{*}^{F} + {{l}^{=}}_{*}^{F} \cdot ( {\overline{k}}_{*}^{F} + {{k}^{=}}_{*}^{F} + k ) + {{l}^{=}}_{*}^{F} - l} = {v}_{*}^{F} - l {Δ}_{F}\end{matrix}$$

where N represents the sequence length of the root sequence, Δ_{T} represents the maximum round-trip time, Δ_{F} represents the maximum Doppler frequency shift,

$$〈 {τ}_{⋆}^{F} , {v}_{⋆}^{F} 〉$$

represents coordinates of the cyclic shift reference point of the root sequence,

$${l}_{⋆}^{F}$$

represents the quantity of Doppler-domain complete cyclic shifts,

$${k}_{⋆}^{F}$$

represents the quantity of delay-domain complete cyclic shifts,

$${\overline{l}}_{⋆}^{F}$$

represents the quantity of Doppler-domain near-end residual cyclic shifts,

$${\overline{k}}_{⋆}^{F}$$

represents the quantity of delay-domain near-end residual cyclic shifts,

$${{l}^{=}}_{*}^{F}$$

represents the quantity of Doppler-domain far-end residual cyclic shifts,

$${{k}^{=}}_{*}^{F}$$

represents the quantity of delay-domain far-end residual cyclic shifts, value ranges of k and l are

$$\{ - {\overline{k}}_{*}^{F} - {{k}^{=}}_{*}^{F} \leq k < - {\overline{k}}_{*}^{F} , 0 < l \leq {{l}^{=}}_{*}^{F} \} ,$$

and an operator sgn(·) represents a sign function.

In a design, the method further includes: determining a first sequence from a sequence set, where the sequence set includes cyclic shift sequences of one or more root sequences; and outputting the first sequence.

According to a second aspect, a communication apparatus is provided. The communication apparatus may be an apparatus, or the communication apparatus is a module or unit (for example, a chip, a chip system, or a circuit) that is in one-to-one correspondence with the method (or referred to as an operation, a step, or an action) in the first aspect and the possible implementations of the first aspect in the apparatus, or an apparatus that can match the apparatus for use.

In an implementation, the apparatus may be a terminal, or a module or unit configured in the terminal (for example, the communication apparatus may be a chip, a chip system, or a circuit configured in the terminal), or an apparatus that matches the terminal for use. In another implementation, the apparatus may be an access network device, an internet of vehicles device, an aircraft, or the like. This is not limited in this disclosure.

According to a third aspect, a computer-readable storage medium is provided, storing a computer program or instructions. When the computer program or the instructions are run on a computer, the computer is enabled to implement the method in the first aspect.

According to a fourth aspect, a computer program product is provided, including a computer program or instructions. When the computer program or the instructions are run by a computer, the method in the first aspect is performed.

According to a fifth aspect, a chip is provided, including a processor. The processor is coupled to a memory, and is configured to execute a computer program or instructions stored in the memory, to enable the chip to implement the method in the first aspect.

### BRIEF DESCRIPTION OF DRAWINGS

FIG. 1 is a diagram of a system architecture according to an embodiment of this disclosure;

FIG. 2 is a flowchart according to an embodiment of this disclosure;

FIG. 3A is a diagram of a delay-domain cyclic shift reference point according to an embodiment of this disclosure;

FIG. 3B is a diagram of a Doppler-domain cyclic shift reference point according to an embodiment of this disclosure;

FIG. 4 is a diagram of a quantity of cyclic shifts corresponding to a Doppler-domain cyclic shift reference point according to an embodiment of this disclosure;

FIG. 5, FIG. 6, FIG. 7, and FIG. 8 are diagrams of a delay-domain cyclic shift reference point and a Doppler-domain cyclic shift reference point according to an embodiment of this disclosure; and

FIG. 9 and FIG. 10 are diagrams of structures of apparatuses according to an embodiment of this disclosure.

### DESCRIPTION OF EMBODIMENTS

To make the objectives, technical solutions, and advantages of this disclosure clearer, the following further describes this disclosure in detail with reference to the accompanying drawings. Specific operation methods, function descriptions, and the like in method embodiments may also be applied to apparatus embodiments or system embodiments.

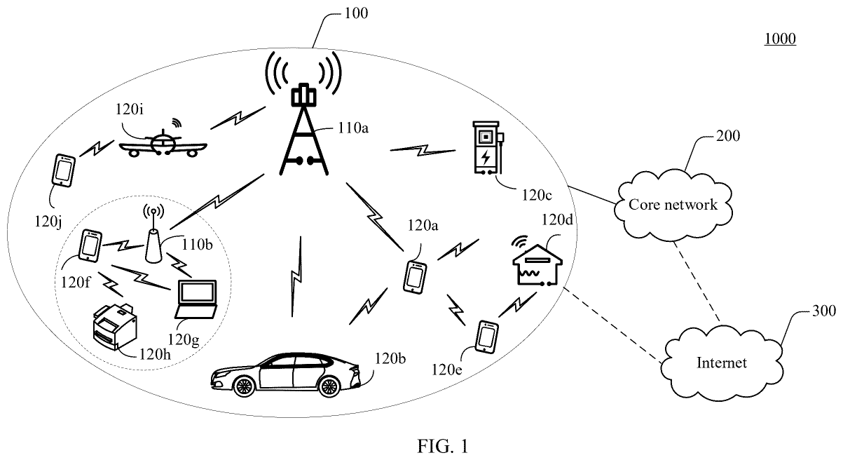

As shown in FIG. 1, a communication system 1000 is provided. The communication system 1000 includes a radio access network 100 and a core network 200. Optionally, the communication system 1000 may further include an internet 300.

The radio access network 100 may include at least one radio access network device, for example, 110a and 110b in FIG. 1, and may further include at least one terminal, for example, 120a to 120j in FIG. 1. The terminal is connected to the radio access network device in a wireless manner, and the radio access network device is connected to the core network in a wireless or wired manner. A core network device and the radio access network device may be different independent physical devices, or functions of the core network device and logical functions of the radio access network device may be integrated into a same physical device, or a part of functions of the core network device and a part of functions of the radio access network device may be integrated into one physical device. A wired or wireless manner may be used for connection between terminals and between radio access network devices. It may be understood that FIG. 1 is merely a diagram. The communication system 1000 may further include another device, for example, may further include a wireless relay device, a wireless backhaul device, and the like, which are not shown in FIG. 1.

The radio access network device may be referred to as an access network device for short. The radio access network device may be a base station, an evolved NodeB (eNodeB), a transmission reception point (TRP), a next generation NodeB (gNB) in a 5th generation (5G) mobile communication system, a next generation base station in a 6th generation (6G) mobile communication system, a base station in a future mobile communication system, an access node in a WI-FI system, or the like, or may be a module or unit that completes some functions of the base station, for example, may be a central unit (CU), or may be a distributed unit (DU). The CU completes functions of a Radio Resource Control (RRC) protocol and a Packet Data Convergence Protocol (PDCP) of the base station, and may further complete a function of a Service Data Adaptation Protocol (SDAP). The DU completes functions of a radio link control (RLC) layer and a medium access control (MAC) layer of the base station, and may further complete a function of a part or all of a physical layer (PHY). For specific descriptions of the foregoing protocol layers, refer to related technical specifications of the 3rd Generation Partnership Project (3GPP). The radio access network device may be a macro base station (such as 110a in FIG. 1), or may be a micro base station or an indoor base station (such as 110b in FIG. 1), or may be a relay node or a donor node. Neither of a specific technology and a specific device form used for the radio access network device is limited in embodiments of this disclosure. For ease of description, the following uses an example in which an access network device is used as the radio access network device for description.

The terminal may also be referred to as a terminal device, user equipment (UE), a mobile station, a mobile terminal, or the like. The terminal may be widely used in various scenarios, for example, device-to-device (D2D), vehicle-to-everything (V2X) communication, machine-type communication (MTC), Internet of things (IOT), virtual reality, augmented reality, industrial control, autonomous driving, telemedicine, smart grid, smart furniture, smart office, smart wearable, smart transportation, and smart city. The terminal may be a mobile phone, a tablet computer, a computer with wireless sending and receiving functions, a wearable device, a vehicle, an uncrewed aerial vehicle, a helicopter, an airplane, a ship, a robot, a robot arm, a smart home device, or the like. Neither of a specific technology and a specific device form used for the terminal is limited in embodiments of this disclosure.

Communication may be performed between an access network device and a terminal, between access network devices, or between terminals by using a licensed spectrum, an unlicensed spectrum, or both a licensed spectrum and an unlicensed spectrum; may be performed by using a spectrum below 6 gigahertz (GHz); may be performed by using a spectrum above 6 GHz; or may be performed by using both a spectrum below 6 GHz and a spectrum above 6 GHz. In embodiments of this disclosure, a spectrum resource used for wireless communication is not limited.

In embodiments of this disclosure, roles of the access network device and the terminal may be relative. For example, a helicopter or an uncrewed aerial vehicle 120i in FIG. 1 may be configured as a mobile access network device, and for a terminal 120j accessing the radio access network 100 through 120i, the terminal 120i is an access network device. However, for the access network device 110a, 120i is a terminal. Communication between 110a and 120i is performed based on a radio air interface protocol. Certainly, 110a and 120i may alternatively communicate with each other by using an interface protocol between access network devices. In this case, compared with 110a, 120i is also an access network device. Therefore, in embodiments of this disclosure, the access network device and the terminal may be collectively referred to as communication apparatuses. 110a and 110b in FIG. 1 may be referred to as communication apparatuses having a function of an access network device, and 120a to 120j in FIG. 1 may be referred to as communication apparatuses having a function of a terminal.

In embodiments of this disclosure, application scenarios of the access network device and the terminal are not limited. For example, the access network device and the terminal may be at fixed locations, or may be movable. The access network device and the terminal may be deployed on land, including an indoor or outdoor device, a handheld device, or a vehicle-mounted device; or may be deployed on a water surface; or may be deployed on a plane, a balloon, and an artificial satellite in the air.

The solutions provided in embodiments of this disclosure may be applied to a 5G communication system, a 6G communication system, an integrated sensing and communication system, or even another communication system in future evolution. This is not limited. In the following descriptions, communication between an access network device and a terminal is mainly used as an example for description. The solutions in embodiments of this disclosure may also be applied to another application scenario, for example, communication between base stations, communication between terminals, and communication in an internet of vehicles, an internet of things, or an industrial internet. This is not limited.

In LTE and NR, different cyclic shifts of a Zadoff-Chu (ZC) root sequence may be used to form a zero-correlation zone. The zero-correlation zone means that a correlation function is equal to zero within a range of a maximum round-trip time (without a Doppler frequency shift). For example, a ZC root sequence is obtained, and a cyclic shift sequence whose correlation function is equal to zero may be obtained by restricting a cyclic shift of the ZC root sequence. A correlation function of any two sequences in the cyclic shift sequence is equal to zero.

To improve a capability of the ZC sequence to resist a Doppler frequency offset, the LTE and NR protocols further restrict the cyclic shift of the ZC root sequence. A zero-ambiguity zone means that an ambiguity function is equal to zero within a range of a maximum round-trip time and a maximum Doppler frequency shift. For example, a ZC root sequence is obtained, and a cyclic shift sequence whose ambiguity function is equal to zero may be obtained by further restricting a cyclic shift of the ZC root sequence. An ambiguity function of any two sequences in the cyclic shift sequence is equal to zero. In release 8, a cyclic shift restricted set type A is proposed to resist a frequency offset of ±1 subcarrier spacings, and an expression of 2 cyclic shifts is obtained based on a relationship between a sequence length, a root index number, and a maximum round-trip time. In release 14, a cyclic shift restricted set type B is proposed to resist a frequency offset of ±2 subcarrier spacings, and an expression of 6 cyclic shifts is obtained based on a relationship between a sequence length, a root index number, and a maximum round-trip time.

In the foregoing solutions, methods for calculating a cyclic shift restricted set are different with respect to requirements for resisting different subcarrier spacing frequency offsets. The solution in the standard is difficult to extend to calculate a cyclic shift restricted set for resisting more subcarrier spacing frequency offsets.

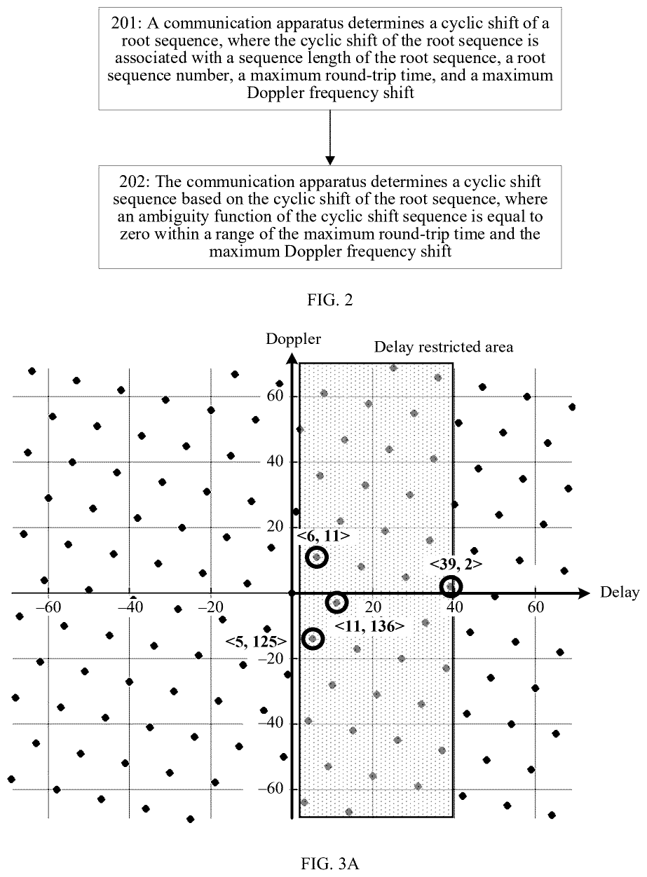

In embodiments of this disclosure, a cyclic shift restricted set for resisting any subcarrier spacing frequency offset may be determined. For example, a subcarrier spacing frequency offset that needs to be resisted currently, that is, the maximum Doppler frequency shift Δ_{F}, is input into the solution of this disclosure, to obtain a corresponding cyclic shift restricted set, or obtain a corresponding cyclic shift sequence. For example, when there is no need to resist a frequency offset, the maximum Doppler frequency shift is Δ_{F}=1; when a frequency offset of ±1 subcarrier spacings is resisted, the maximum Doppler frequency shift is Δ_{F}=3; when a frequency offset of ±2 subcarrier spacings is resisted, the maximum Doppler frequency shift is Δ_{F}=5; or when a frequency offset of ±f subcarrier spacings is resisted, the maximum Doppler frequency shift is Δ_{F}=2·f+1. As shown in FIG. 2, a procedure is provided, and the procedure includes the following steps.

Step 201: A communication apparatus determines a cyclic shift of a root sequence, where the cyclic shift of the root sequence is associated with a sequence length N of the root sequence, a root sequence number u, a maximum round-trip time Δ_{T}, and a maximum Doppler frequency shift Δ_{F}. Alternatively, a description is as follows: a communication apparatus determines a cyclic shift of a root sequence based on a sequence length N of the root sequence, a root sequence number u, a maximum round-trip time Δ_{T}, and a maximum Doppler frequency shift Δ_{F}.

In a design, the communication apparatus may determine a delay-domain cyclic shift reference point and a Doppler-domain cyclic shift reference point based on the root sequence. The communication apparatus determines a quantity of cyclic shifts corresponding to the delay-domain cyclic shift reference point and a quantity of cyclic shifts corresponding to the Doppler-domain cyclic shift reference point. The communication apparatus selects a cyclic shift reference point with a largest quantity of cyclic shifts from the delay-domain cyclic shift reference point and the Doppler-domain cyclic shift reference point as a cyclic shift reference point of the root sequence. The communication apparatus determines the cyclic shift of the root sequence based on the cyclic shift reference point of the root sequence. It should be noted that when determining the delay-domain cyclic shift reference point, the communication apparatus needs to determine a delay restricted area. The delay restricted area is determined by the sequence length N of the root sequence, the root sequence number u, the maximum round-trip time Δ_{T}, and the maximum Doppler frequency shift Δ_{F}. Similarly, when determining the Doppler-domain cyclic shift reference point, the communication apparatus needs to determine a Doppler restricted area. The Doppler restricted area is determined by the sequence length N of the root sequence, the root sequence number u, the maximum round-trip time Δ_{T}, and the maximum Doppler frequency shift Δ_{F}. Further, when determining the quantity of cyclic shifts corresponding to the delay-domain cyclic shift reference point, the communication apparatus needs to determine parameters such as a quantity of delay-domain complete cyclic shifts, a quantity of Doppler-domain complete cyclic shifts, a quantity of delay-domain near-end residual cyclic shifts, a quantity of Doppler-domain near-end residual cyclic shifts, a quantity of delay-domain far-end residual cyclic shifts, and a quantity of Doppler-domain far-end residual cyclic shifts. The foregoing 6 parameters are associated with the sequence length N of the root sequence, the root sequence number u, the maximum round-trip time Δ_{T}, and the maximum Doppler frequency shift Δ_{F}. For example, when the quantity of delay-domain complete cyclic shifts is determined, the factor maximum round-trip time Δ_{T} needs to be considered. When the quantity of Doppler-domain complete cyclic shifts is determined, the factor maximum Doppler frequency shift Δ_{F} needs to be considered. Similarly, when the quantity of cyclic shifts corresponding to the Doppler-domain cyclic shift reference point is determined, the foregoing 6 parameters also need to be determined. The 6 parameters are associated with the sequence length N of the root sequence, the root sequence number u, the maximum round-trip time Δ_{T}, and the maximum Doppler frequency shift Δ_{F}. For a specific relationship, refer to descriptions in the following formulas. Further, when determining the cyclic shift of the root sequence based on the cyclic shift reference point of the root sequence, the communication apparatus also needs to consider factors such as the sequence length N of the root sequence, the root sequence number u, the maximum round-trip time Δ_{T}, and the maximum Doppler frequency shift Δ_{F}. For a specific relationship, refer to the following formulas. Therefore, in this embodiment of this disclosure, it may also be described as that the cyclic shift of the root sequence is associated with the sequence length N of the root sequence, the root sequence number u, the maximum round-trip time Δ_{T}, and the maximum Doppler frequency shift Δ_{F}.

Step 202: The communication apparatus determines a cyclic shift sequence based on the cyclic shift of the root sequence, where an ambiguity function of the cyclic shift sequence is equal to zero within a range of the maximum round-trip time Δ_{T} and the maximum Doppler frequency shift Δ_{F}. Alternatively, it may be described as that the cyclic shift sequence determined in step 202 includes one or more sequences. When a plurality of sequences are included, ambiguity functions of any two of the plurality of sequences are equal to zero within the range of the maximum round-trip time Δ_{T} and the maximum Doppler frequency shift Δ_{F}.

In this embodiment of this disclosure, the root sequence satisfies:

$${s}_{u , v} ( n ) = {e}^{- j π u ( n + {C}_{v} ) ( n + {C}_{v} + 1 ) / N}$$

N represents the sequence length of the root sequence, N is a prime number, u represents the root sequence number, a value range of u is 1≤u≤N−1, n represents a symbol index of the cyclic shift sequence, a value range of n is 0≤n≤N−1, v represents an index of the cyclic shift of the root sequence, and Cᵥ represents the cyclic shift of the root sequence.

It should be noted that, in the foregoing expression of the root sequence, a value of the cyclic shift Cᵥ of the root sequence is equal to 0. In other words, when the cyclic shift of the root sequence is Cᵥ=0, the foregoing expression represents the root sequence.

In this embodiment of this disclosure, the communication apparatus first obtains the root sequence. The communication apparatus may determine the value of the cyclic shift Cᵥ of the root sequence according to step 201. The communication apparatus may determine the cyclic shift sequence by substituting the value of the cyclic shift Cᵥ of the root sequence into the foregoing formula. The following describes in detail that the communication apparatus may obtain values of cyclic shifts Cᵥ of one or more root sequences, and substitute a value of a cyclic shift Cᵥ of each root sequence into the foregoing expression, to obtain a corresponding sequence. The cyclic shift sequence determined in step 202 includes one or more sequences. In a description, in step 202, the communication apparatus determines, based on the cyclic shift Cᵥ of the root sequence, that the cyclic shift sequence s_{u,v}(n) satisfies the foregoing expression, that is, satisfies:

$${s}_{u , v} ( n ) = {e}^{- j π u ( n + {C}_{v} ) ( n + {C}_{v} + 1 ) / N}$$

In a design, two sequences included in the cyclic shift sequence determined in the procedure in FIG. 2 may be respectively represented as s_{u,v}_{₁}(n) and s_{u,v}_{₂}(n). Ambiguity functions A(τ, v) of the two sequences are equal to zero within the range of the maximum round-trip time Δ_{T} and the maximum Doppler frequency shift Δ_{F}, and satisfy:

$$A ( τ , v ) = {\sum }_{n = 0}^{N - 1} {s}_{u , {v}_{1}} ( n ) {s}_{u , {v}_{2}}^{*} ( n - τ ) {e}^{j 2 π nv / N} = \{ \begin{matrix}N , & {v}_{1} = {v}_{2} , τ = 0 , v = 0 \\ 0 , & ( {v}_{1} \neq {v}_{2} ∨ ( τ \neq 0 ) ∨ ( v \neq 0 )\end{matrix}$$

N represents the sequence length of the root sequence, u represents the root sequence number, v₁ and v₂ represent indexes of cyclic shifts of the root sequence, τ represents a delay coordinate of the ambiguity function, a value range of τ is 0≤τ≤Δ_{T}−1, v represents a Doppler coordinate of the ambiguity function, a value range of v is 0≤τ≤Δ_{F}−1, an operator (·)* represents a complex conjugate, and an operator V represents conditional OR.

For example, the maximum round-trip time Δ_{T} is related to a location of a terminal, and the maximum Doppler frequency shift Δ_{F} is related to a moving speed of the terminal. Within a specific cell radius, if the moving speed of the terminal satisfies a limitation of the maximum Doppler frequency shift Δ_{F}, mutual interference between any two sequences in the cyclic shift sequence is minimum, or mutual interference between any two sequences is equal to zero.

The following continues to describe a process in which the communication apparatus determines the cyclic shift Cᵥ of the root sequence, that is, an implementation process of step 201.

In a design, a specific implementation of step 201 includes: the communication apparatus determines a cyclic shift reference point of the root sequence based on a delay-domain cyclic shift reference point and a Doppler-domain cyclic shift reference point; and the communication apparatus determines the cyclic shift Cᵥ of the root sequence based on the cyclic shift reference point of the root sequence.

Optionally, an ambiguity function of the root sequence is at all peak points in a given area. If a delay spacing and a Doppler spacing between a peak point and an origin of coordinates are not both greater than a delay spacing and a Doppler spacing between any peak point of the ambiguity function other than the origin of coordinates on a two-dimensional plane and the origin of coordinates, the peak point is the cyclic shift reference point. Cyclic shift reference points are classified into a delay-domain cyclic shift reference point and a Doppler-domain cyclic shift reference point based on different given areas.

### [Delay-Domain Cyclic Shift Reference Point]

The communication apparatus determines the delay-domain cyclic shift reference point based on the ambiguity function of the root sequence. The delay-domain cyclic shift reference point includes one or more cyclic shift reference points.

In a design, the communication apparatus may determine a delay restricted area in a delay-Doppler coordinate system. A horizontal axis of the delay-Doppler coordinate system indicates a delay domain, and a vertical axis indicates a Doppler domain. The delay restricted area includes one or more peak points of the root sequence, and the peak point is determined based on the ambiguity function of the root sequence. The communication apparatus determines that the peak point of the root sequence included in the delay restricted area is the delay-domain cyclic shift reference point.

Optionally, the delay restricted area satisfies: a rectangular area including a start coordinate in the delay domain being Δ_{T}, an end coordinate in the delay domain being min_{v∈{±1, ±2, . . . , ±(Δ}_{_{F}}_{-1)}}{u⁻¹v mod N}, a start coordinate in the Doppler domain being 0, and an end coordinate in the Doppler domain being N−1. N represents the sequence length of the root sequence, u represents the root sequence number, Δ_{T} represents the maximum round-trip time, Δ_{F} represents the maximum Doppler frequency shift, and an operator (·)⁻¹ represents a multiplicative inverse.

In an implementation, the communication apparatus determines the delay restricted area; and the communication apparatus determines the peak point of the root sequence in the delay restricted area. For example, in the delay restricted area, the communication apparatus calculates the peak point of the root sequence based on the ambiguity function. The communication apparatus selects, from the peak point in the delay restricted area, a peak point that satisfies a condition, where the peak point that satisfies the condition is the delay-domain cyclic shift reference point. Optionally, in the delay restricted area, a peak point that satisfies the following condition may be considered as the delay-domain cyclic shift reference point: a delay spacing and a Doppler spacing between the peak point and the origin of coordinates are not both greater than a delay spacing and a Doppler spacing between any peak point other than the origin of coordinates on a two-dimensional plane and the origin of coordinates.

In a design, a set [symbol] including coordinates of the delay-domain cyclic shift reference point satisfies:

$$S \_ T {=}^{Δ} \{ 〈 τ\_ 1 \hat{} T , v \_ 1 \hat{} T 〉 , 〈 τ\_ 2 \hat{} T , v \_ 2 \hat{} T 〉 , … , 〈 τ\_ \vert S \_ T \vert \hat{} T , v \_ \vert S \_ T \vert \hat{} T 〉 \} = \{ 〈 τ , u τ mod N 〉 \vert min \{ \pm u τ mod N \} < min ⊤ ( n = 1 , 2 , … , τ - 1 ) \{ \pm u n mod N \} , τ ∈ \{ Δ\_ T , Δ\_ T + 1 , … , min ⊤ ( τ ∈ \{ \pm 1 , \pm 2 , … , \pm ( Δ\_ F - 1 ) \} ) ( u \hat{} ( - 1 ) v mod N \} \} \}$$

N represents the sequence length of the root sequence, u represents the root sequence number, Δ_{T} represents the maximum round-trip time, Δ_{F} represents the maximum Doppler frequency shift,

$$〈 {τ}_{1}^{T} , {v}_{1}^{T} 〉$$

represents coordinates or an i^{th} delay-domain cyclic shift reference point, a value range of i is 1≤i≤| [symbol] |, an operator (·)⁻¹ represents a multiplicative inverse, an operator |·| represents a cardinality of the set, and a mark “T” represents the delay domain.

### [Doppler-Domain Cyclic Shift Reference Point]

The communication apparatus determines the Doppler-domain cyclic shift reference point based on the ambiguity function of the root sequence. The Doppler-domain cyclic shift reference point includes one or more cyclic shift reference points.

In an implementation, the communication apparatus determines a Doppler restricted area in the delay-Doppler coordinate system, where the horizontal axis in the delay-Doppler coordinate system indicates the delay domain, and the vertical axis indicates the Doppler domain. The Doppler restricted area includes one or more peak points of the root sequence, and the peak point is determined based on the ambiguity function of the root sequence. The communication apparatus determines that the peak point of the root sequence included in the Doppler restricted area is the Doppler-domain cyclic shift reference point. The Doppler-domain cyclic shift reference point includes one or more cyclic shift reference points.

In a design, the Doppler restricted area satisfies: a rectangular area including a start coordinate in the delay domain being 0, an end coordinate in the delay domain being N−1, a start coordinate in the Doppler domain being Δ_{F}, and an end coordinate in the Doppler domain being min_{τ∈{±1, ±2, . . . , ±(Δ}_{_{T}}_{-1)}}{uτ mod N}. N represents the sequence length of the root sequence, u represents the root sequence number, Δ_{T} represents the maximum round-trip time, and Δ_{F} represents the maximum Doppler frequency shift.

In an implementation, the communication apparatus determines the Doppler restricted area; and the communication apparatus determines the peak point of the root sequence in the Doppler restricted area. For example, in the Doppler restricted area, the communication apparatus calculates the peak point of the root sequence based on the ambiguity function. The communication apparatus selects, from the peak point in the Doppler restricted area, a peak point that satisfies a condition, where the peak point that satisfies the condition may be considered as the Doppler-domain cyclic shift reference point. Optionally, in the Doppler restricted area, a peak point that satisfies the following condition may be considered as the Doppler-domain cyclic shift reference point: a delay spacing and a Doppler spacing between the peak point and the origin of coordinates are not both greater than a delay spacing and a Doppler spacing between any peak point other than the origin of coordinates on a two-dimensional plane and the origin of coordinates.

In a design, a set | [symbol] | including coordinates of the Doppler-domain cyclic shift reference point satisfies:

$$S \_ F {=}^{Δ} \{ 〈 τ\_ 1 \hat{} F , v \_ 1 \hat{} F 〉 , 〈 τ\_ 2 \hat{} F , v \_ 2 \hat{} F 〉 , … , 〈 τ\_ \vert S \_ F \vert \hat{} F , v \_ \vert S \_ F \vert \hat{} F 〉 \} = \{ 〈 u \hat{} ( - 1 ) v mod N , v 〉 \vert min \{ \pm u \hat{} ( - 1 ) v mod N \} < min ⊤ ( n = 1 , 2 , … , v - 1 ) \{ \pm u \hat{} ( - 1 ) n mod N \} , v ∈ \{ Δ\_ F , Δ\_ F + 1 , … , min ⊤ ( τ ∈ \{ \pm 1 , \pm 2 , … , \pm ( Δ\_ T - 1 ) \} ) ( u τ mod N \} \} \}$$

N represents the sequence length of the root sequence, u represents the root sequence number, Δ_{T} represents the maximum round-trip time, Δ_{F} represents the maximum Doppler frequency shift,

$$〈 {τ}_{*}^{F} , {v}_{*}^{F} 〉$$

represents an i^{th} Doppler-domain cyclic shift reference point, a value range of i is 1≤i≤| [symbol] |, an operator (·)⁻¹ represents a multiplicative inverse, an operator |·| represents a cardinality of the set, and a mark “F” represents the Doppler domain.

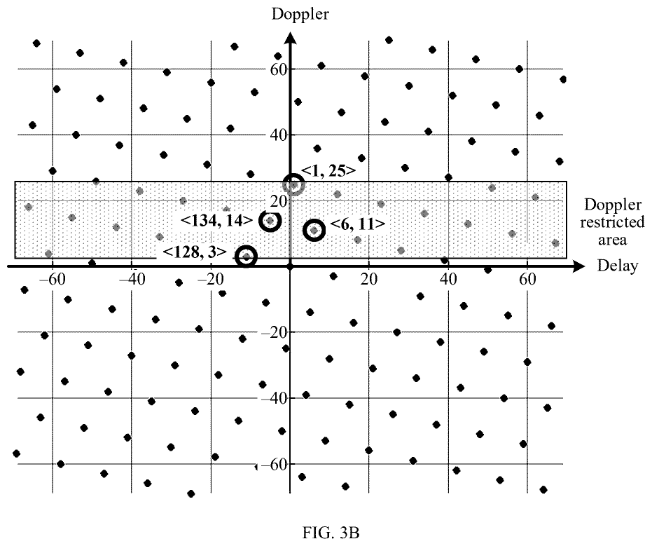

For example, FIG. 3A and FIG. 3B show diagrams of a delay-domain cyclic shift reference point and a Doppler-domain cyclic shift reference point when N=139, u=25, Δ_{T}×Δ_{F}=2×3. As shown in FIG. 3A, in the delay restricted area, a start coordinate in the delay domain is 2, an end coordinate in the delay domain is 39, a start coordinate in the Doppler domain is 0, and an end coordinate in the Doppler domain is 138. The delay-domain cyclic shift reference point includes 4 cyclic shift reference points, and coordinates of the cyclic shift reference points are respectively [symbol] 5,125 [symbol] , [symbol] 6,11 [symbol] , [symbol] 11,136 [symbol] , [symbol] 39,2 [symbol] . As shown in FIG. 3B, in the Doppler restricted area, a start coordinate in the delay domain is 0, an end coordinate in the delay domain is 138, a start coordinate in the Doppler domain is 3, and an end coordinate in the Doppler domain is 25. The Doppler-domain cyclic shift reference point includes 4 cyclic shift reference points, and coordinates of the cyclic shift reference points are respectively [symbol] 128,3 [symbol] , [symbol] 6,11 [symbol] , [symbol] 134,14 [symbol] , [symbol] 1,25 [symbol] . Optionally, a quantity of delay-domain cyclic shift reference points is equal to a quantity of Doppler-domain cyclic shift reference points, that is, | [symbol] |=| [symbol] |.

It should be noted that, for some specific sequence lengths N, root sequence numbers u, maximum round-trip times Δ_{T}, and maximum Doppler frequency shifts Δ_{F}, according to the method in this embodiment of this disclosure, there may be no delay-domain cyclic shift reference point or Doppler-domain cyclic shift reference point. In this case, a set that includes the delay-domain cyclic shift reference point and the Doppler-domain cyclic shift reference point determined in step 202 is an empty set, that is, no cyclic shift sequence satisfies a zero-ambiguity zone condition, including the root sequence.

### [Cyclic Shift Reference Point of the Root Sequence]

In a design, the communication apparatus determines a quantity of cyclic shifts corresponding to the delay-domain cyclic shift reference point and a quantity of cyclic shifts corresponding to the Doppler-domain cyclic shift reference point. The communication apparatus selects a reference point with a largest quantity of cyclic shifts from the delay-domain cyclic shift reference point and the Doppler-domain cyclic shift reference point as a cyclic shift reference point of the root sequence. In a design, coordinates of the cyclic shift reference point of the root sequence are

$$〈 {τ}_{*}^{†} , {v}_{*}^{†} 〉 ,$$

and a quantity

$${Ω}_{*}^{†}$$

of cyclic shifts corresponding to the cyclic shift reference point satisfies:

$${Ω}_{*}^{†} = max \{ {Ω}_{1}^{T} , {Ω}_{2}^{T} , … {Ω}_{\vert {S}_{T} \vert}^{T} , {Ω}_{1}^{F} , {Ω}_{2}^{F} , … {Ω}_{\vert {S}_{T} \vert}^{F} \}$$

$${Ω}_{1}^{T} , {Ω}_{2}^{T} , … {Ω}_{\vert {S}_{T} \vert}^{T}$$

represents the quantity of cyclic shifts corresponding to the delay-domain cyclic shift reference point,

$${Ω}_{1}^{F} , {Ω}_{2}^{F} , … {Ω}_{\vert {S}_{T} \vert}^{F}$$

represents the quantity of cyclic shifts corresponding to the Doppler-domain cyclic shift reference point, and

$${Ω}_{*}^{†}$$

represents the quantity of cyclic shifts corresponding to the cyclic shift reference point of the root sequence.

In other words, the communication apparatus selects a cyclic shift reference point with a largest quantity of cyclic shifts from the delay-domain cyclic shift reference point and the Doppler-domain cyclic shift reference point as a cyclic shift reference point of the root sequence. It should be noted that, in the foregoing expression, when †=T, it indicates that the cyclic shift reference point of the root sequence is a ★*th delay-domain cyclic shift reference point; or when †=F, it indicates that the cyclic shift reference point of the root sequence is a ★^{th} Doppler-domain cyclic shift reference point.

For example, when N=139, u=25, Δ_{T}×Δ_{F}=2×3, the delay-domain cyclic shift reference point includes 4 cyclic shift reference points, and coordinates of the cyclic shift reference points are respectively

$$〈 {τ}_{1}^{T} , {v}_{1}^{T} 〉 = 〈 5 , 125 〉 ,$$

$$〈 {τ}_{2}^{T} , {v}_{2}^{T} 〉 = 〈 6 , 11 〉 ,$$

$$〈 {τ}_{3}^{T} , {v}_{3}^{T} 〉 = 〈 11 , 136 〉 ,$$

$$〈 {τ}_{4}^{T} , {v}_{4}^{T} 〉 = 〈 39 , 2 〉 .$$

Quantities of cyclic shifts corresponding to the 4 cyclic shift reference points are respectively

$${Ω}_{1}^{F} = 21 ,$$

$${Ω}_{2}^{F} = 20 ,$$

$${Ω}_{3}^{F} = 19 ,$$

$${Ω}_{4}^{F} = 19.$$

The Doppler-domain cyclic shift reference point includes 4 cyclic shift reference points, and coordinates of the cyclic shift reference points are respectively

$$〈 {τ}_{1}^{F} , {v}_{1}^{F} 〉 = 〈 128 , 3 〉 , 〈 {τ}_{2}^{F} , {v}_{2}^{F} 〉 = 〈 6 , 11 〉 , 〈 {τ}_{3}^{F} , {v}_{3}^{F} 〉 = 〈 134 , 14 〉 ,$$

$$〈 {τ}_{4}^{F} , {v}_{4}^{F} 〉 = 〈 1 , 25 〉 .$$

Quantities of cyclic shifts corresponding to the 4 cyclic shift reference points are respectively

$${Ω}_{1}^{F} = 19 , {Ω}_{2}^{F} = 20 , {Ω}_{3}^{F} = 20 , {Ω}_{4}^{F} = 21 .$$

Based on a principle of selecting a cyclic shift reference point with a largest quantity of cyclic shifts as a cyclic shift reference point of the root sequence, the selected cyclic shift reference point of the root sequence is a delay-domain cyclic shift reference point, coordinates of the selected cyclic shift reference point are

$$〈 {τ}_{⋆}^{†} , {v}_{⋆}^{†} 〉 = 〈 {τ}_{1}^{F} , {v}_{1}^{F} 〉 = 〈 5 , 125 〉 .$$

and a corresponding quantity of cyclic shifts is

$${Ω}_{⋆}^{†} = {Ω}_{1}^{T} = 21 .$$

It should be noted that coordinates of the delay-domain cyclic shift reference point determined by the communication apparatus are represented as

$$\{ 〈 {τ}_{1}^{T} , {v}_{1}^{T} 〉 , 〈 {τ}_{2}^{T} , {v}_{2}^{T} 〉 , … , 〈 {τ}_{\vert {𝒮}_{T} \vert}^{T} , {v}_{\vert {𝒮}_{T} \vert}^{T} 〉 \} .$$

Each cyclic shift reference point in the delay-domain cyclic shift reference point corresponds to one quantity of cyclic shifts. In the foregoing expression, the quantity of cyclic shifts corresponding to the delay-domain cyclic shift reference point is represented as

$${Ω}_{1}^{T} , {Ω}_{2}^{T} , … {Ω}_{\vert {𝒮}_{T} \vert}^{T} . \vert {𝒮}_{T} \vert$$

is an integer greater than or equal to 0. A mark “ . . . ” represents ellipsis, which indicates that quantities of cyclic shifts corresponding to a plurality of cyclic shift reference points with consecutive numbers or indexes are omitted. It may be understood that when a value of | [symbol] | is 1, the delay-domain cyclic shift reference point includes 1 cyclic shift reference point, and a quantity of cyclic shifts corresponding to the 1 cyclic shift reference point is represented as

$${Ω}_{1}^{T} .$$

When a value of | [symbol] | is 2, the delay-domain cyclic shift reference point includes 2 cyclic shift reference points, and quantities of cyclic shifts corresponding to the 2 cyclic shift reference points are respectively represented as

$${Ω}_{1}^{T} , {Ω}_{2}^{T} .$$

It may be understood that a value of | [symbol] | may be 0, indicating that the delay-domain cyclic shift reference point does not include any cyclic shift reference point. In this case, it indicates that there is no peak point that satisfies a condition in the delay restricted area.

Similarly, coordinates of the Doppler-domain cyclic shift reference point determined by the communication apparatus are represented as

$$〈 {τ}_{1}^{F} , {v}_{1}^{F} 〉 , 〈 {τ}_{2}^{F} , {v}_{2}^{F} 〉 , … , 〈 {τ}_{\vert {𝒮}_{F} \vert}^{F} , {v}_{\vert {𝒮}_{F} \vert}^{F} 〉 .$$

Each cyclic shift reference point in the Doppler-domain cyclic shift reference point corresponds to one quantity of cyclic shifts. In the foregoing expression, the quantity of cyclic shifts corresponding to the Doppler-domain cyclic shift reference point is represented as

$${Ω}_{1}^{F} , {Ω}_{2}^{F} , … , {Ω}_{\vert {𝒮}_{F} \vert}^{F} . \vert {𝒮}_{F} \vert$$

is an integer greater than or equal to 0. A mark “ . . . ” represents ellipsis, which indicates that quantities of cyclic shifts corresponding to a plurality of cyclic shift reference points with consecutive numbers or indexes are omitted. It may be understood that when a value of | [symbol] | is 1, the Doppler-domain cyclic shift reference point includes 1 cyclic shift reference point, and a quantity of cyclic shifts corresponding to the 1 cyclic shift reference point is represented as

$${Ω}_{1}^{F} .$$

When a value of | [symbol] | is 2, the Doppler-domain cyclic shift reference point includes 2 cyclic shift reference points, and quantities of cyclic shifts corresponding to the 2 cyclic shift reference points are represented as

$${Ω}_{1}^{F} , {Ω}_{2}^{F} .$$

It may be understood that a value of | [symbol] | may be 0, indicating that the Doppler-domain cyclic shift reference point does not include any cyclic shift reference point. In this case, it indicates that there is no peak point that satisfies a condition in the Doppler restricted area.

### [Quantity of Cyclic Shifts Corresponding to the Delay-Domain Cyclic Shift Reference Point]

The delay-domain cyclic shift reference point includes one or more cyclic shift reference points. In the following description, coordinates of any cyclic shift reference point in the delay-domain cyclic shift reference point are represented as

$$〈 {τ}_{i}^{T} , {v}_{i}^{T} 〉 ,$$

a value range of i is 1≤i≤| [symbol] |, and a quantity of cyclic shifts corresponding to the cyclic shift reference point is represented as

$${Ω}_{i}^{T} .$$

For ease or description, the following description is used below: coordinates

$$〈 {τ}_{i}^{T} , {v}_{i}^{T} 〉$$

of the delay-domain cyclic shift reference point.

In a design, the communication apparatus determines a quantity

$${k}_{i}^{T}$$

of delay-domain complete cyclic shifts, a quantity

$${l}_{i}^{T}$$

of Doppler-domain complete cyclic summits, a quantity

$${\overline{k}}_{i}^{T}$$

of delay-domain near-end residual cyclic shifts, a quantity

$${\overline{l}}_{i}^{T}$$

of Doppler-domain near-end residual cyclic shifts, a quantity

$${{k}^{=}}_{i}^{T}$$

of delay-domain tar-end residual cyclic shifts, and a quantity

$${{l}^{=}}_{i}^{T}$$

of Doppler-domain far-end residual cyclic shifts based on the coordinates

$$〈 {τ}_{i}^{T} , {v}_{i}^{T} 〉$$

of the delay-domain cyclic shift reference point. The communication apparatus determines a quantity

$${k}_{i}^{T} \cdot {l}_{i}^{T}$$

of complete cyclic shifts based on the quantity

$${k}_{i}^{T}$$

of delay-domain complete cyclic shifts and the quantity

$${l}_{i}^{T}$$

of Doppler-domain complete cyclic shifts. The communication apparatus determines a quantity

$${\overline{k}}_{i}^{T} \cdot {\overline{l}}_{i}^{T}$$

of near-end residual cyclic shifts based on the quantity

$${\overline{k}}_{i}^{T}$$

of delay-domain near-end residual cyclic shifts and the quantity

$${\overline{l}}_{i}^{T}$$

of Doppler-domain near-end residual cyclic shifts. The communication apparatus determines a quantity

$${{k}^{=}}_{i}^{T} \cdot {{l}^{=}}_{i}^{T}$$

of far-end residual cyclic shifts based on the quantity

$${{k}^{=}}_{i}^{T}$$

of delay-domain tar-end residual cyclic shifts and the quantity

$${{l}^{=}}_{i}^{T}$$

of Doppler-domain far-end residual cyclic shifts. The communication apparatus determines, based on the quantity

$${k}_{i}^{T} \cdot {l}_{i}^{T}$$

of complete cyclic shifts, the quantity

$${\overline{k}}_{i}^{T} \cdot {\overline{l}}_{i}^{T}$$

of near-end residual cyclic shifts, and the quantity

$${{k}^{=}}_{i}^{T} \cdot {{l}^{=}}_{i}^{T}$$

of far-end residual cyclic shifts, the quantity

$${Ω}_{i}^{T}$$

of cyclic shifts corresponding to the delay-domain cyclic shift reference point whose coordinates are

$$〈 {τ}_{i}^{T} , {v}_{i}^{T} 〉 .$$

For example, the quantity

$${Ω}_{i}^{T}$$

of cyclic shifts corresponding to the coordinates

$$〈 {τ}_{i}^{T} , {v}_{i}^{T} 〉$$

of the delay-domain cyclic shift reference point satisfies:

$${Ω}_{i}^{T} = {k}_{i}^{T} \cdot {l}_{i}^{T} + {\overline{k}}_{i}^{T} \cdot {\overline{l}}_{i}^{T} + {{k}^{=}}_{i}^{T} \cdot {{l}^{=}}_{i}^{T}$$

$${k}_{i}^{T}$$

represents the quantity of delay-domain complete cyclic shifts,

$${l}_{i}^{T}$$

represents the quantity of Doppler-domain complete cyclic shifts,

$${\overline{k}}_{i}^{T}$$

represents the quantity of delay-domain near-end residual cyclic shifts,

$${\overline{l}}_{i}^{T}$$

represents the quantity of Doppler-domain near-end residual cyclic shifts,

$${{k}^{=}}_{i}^{T}$$

represents the quantity of delay-domain far-end residual cyclic shifts, and

$${{l}^{=}}_{i}^{T}$$

represents the quantity of Doppler-domain far-end residual cyclic shifts.

In other words, the communication apparatus adds the quantity

$${k}_{i}^{T} \cdot {l}_{i}^{T}$$

of complete cyclic shifts, the quantity

$${\overline{k}}_{i}^{T} \cdot {\overline{l}}_{i}^{T}$$

of near-end residual cyclic shifts, and the quantity

$${\overline{\overline{k}}}_{i}^{T} \cdot {\overline{\overline{l}}}_{i}^{T}$$

of far-end residual cyclic shifts that are of the delay-domain cyclic shift reference point whose corresponding are

$$〈 {τ}_{i}^{T} , {v}_{i}^{T} 〉 ,$$

and uses a sum of the three as the quantity

$${Ω}_{i}^{T}$$

of cyclic shifts corresponding to the delay-domain cyclic shift reference points who coordinates are

$$〈 {τ}_{i}^{T} , {v}_{i}^{T} 〉 .$$

### [Quantity

$${k}_{i}^{T}$$

### Of Delay-Domain Complete Cyclic Shifts]

In a design, the communication apparatus may determine the quantity

$${k}_{i}^{T}$$

of delay-domain complete cyclic shifts based on the coordinates

$$〈 {τ}_{i}^{T} , {v}_{i}^{T} 〉$$

of the delay-domain cyclic shift reference point. For example, in an implementation, the quantity

$${k}_{i}^{T}$$

of delay-domain complete cyclic shifts satisfies:

$${k}_{i}^{T} = ⌊ {τ}_{i}^{T} / {Δ}_{T} ⌋$$

Δ_{T} represents the maximum round-trip time, and an operator └·┘ represents rounding down.

### [Quantity

$${l}_{i}^{T}$$

### Of Doppler-Domain Complete Cyclic Shifts]

In a design, the communication apparatus may determine restriction coordinates

$$〈 {\overline{τ}}_{i}^{T} , {\overline{v}}_{i}^{T} 〉$$

based on the coordinates

$$〈 {τ}_{i}^{T} , {v}_{i}^{T} 〉$$

of the delay-domain cyclic shift reference point. For example, in an implementation, the restriction coordinates

$$〈 {\overline{τ}}_{i}^{T} , {\overline{v}}_{i}^{T} 〉$$

satisfy:

$$\{ \begin{matrix}{\overline{τ}}_{i}^{T} = {min}_{v ∈ \{ 1 , 2 , … , max \{ {Δ}_{F} - 1 , min \{ {v}_{i}^{T} , N - {v}_{i}^{T} \} - 1 \} \}} \{ sgn ( {v}_{i}^{T} - N / 2 ) {u}^{- 1} v mod N \} \\ {\overline{v}}_{i}^{T} = u {\overline{τ}}_{i}^{T} mod N\end{matrix}$$

N represents the sequence length of the root sequence, u represents the root sequence number, Δ_{F} represents the maximum Doppler frequency shift, and an operator (·)⁻¹ represents a multiplicative inverse.

The communication apparatus determines a Doppler spacing

$${d}_{i}^{T}$$

based on the coordinates

$$〈 {τ}_{i}^{T} , {v}_{i}^{T} 〉$$

of the delay-domain cyclic shift reference point and the restriction coordinates

$$〈 {\overline{τ}}_{i}^{T} , {\overline{v}}_{i}^{T} 〉 .$$

In an implementation, the Doppler spacing

$${d}_{i}^{T}$$

satisfies:

$${d}_{i}^{T} = min \{ d \vert {τ}_{i}^{T} - ( ⌊ \frac{d / {Δ}_{F}}{⌈ min \{ {v}_{i}^{T} , N - {v}_{i}^{T} \} / {Δ}_{F} ⌉} ⌋ + 1 ) \cdot {τ}_{i}^{T} {modΔ}_{T} \geq {\overline{τ}}_{i}^{T} - ⌊ \frac{d - min \{ {\overline{v}}_{i}^{T} , N - {\overline{v}}_{i}^{T} \}}{min \{ {v}_{i}^{T} , N - {v}_{i}^{T} \}} ⌋ \cdot {τ}_{i}^{T} \}$$

N represents the sequence length of the root sequence, Δ_{T} represents the maximum round-trip time, Δ_{F} represents the maximum Doppler frequency shift, an operator └·┘ represents rounding down, and an operator ┌·┐ represents rounding up.

The communication apparatus determines the quantity

$${l}_{i}^{T}$$

of Doppler-domain complete cyclic shifts based on the Doppler spacing

$${d}_{i}^{T} .$$

In an implementation, the quantity

$${l}_{i}^{T}$$

of Doppler-domain complete cyclic shifts satisfies:

$${l}_{i}^{T} = ⌊ {d}_{i}^{T} / {Δ}_{F} ⌋$$

Δ_{F} represents the maximum Doppler frequency shift,

$${d}_{i}^{T}$$

represents the Doppler spacing, and an operator └·┘ represents rounding down.

### [Quantity

$${\overline{k}}_{i}^{T}$$

### Of Delay-Domain Near-End Residual Cyclic Shifts]

In a design, the communication apparatus may determine the quantity

$${\overline{k}}_{i}^{T}$$

of delay-domain near-end residual cyclic shifts based on the coordinates

$$〈 {τ}_{i}^{T} , {v}_{i}^{T} 〉$$

of the delay-domain cyclic shift reference point, the restriction coordinates

$$〈 {\overline{τ}}_{i}^{T} , {\overline{v}}_{i}^{T} 〉 ,$$

and the quantity

$${l}_{i}^{T}$$

of Doppler-domain complete cyclic shifts. In an implementation, the quantity

$${\overline{k}}_{i}^{T}$$

of delay-domain near-end residual cyclic shifts satisfies:

$${\overline{k}}_{i}^{T} = max \{ ⌊ ( {\overline{τ}}_{i}^{T} - ⌊ \frac{{d}_{i}^{T} - min \{ {\overline{ν}}_{i}^{T} , N - {\overline{ν}}_{i}^{T} \}}{min \{ {ν}_{i}^{T} , N - {ν}_{i}^{T} \}} ⌋ \cdot {τ}_{i}^{T} + ( ⌊ \frac{{l}_{i}^{T} - 1}{⌈ min \{ {ν}_{i}^{T} , N - {ν}_{i}^{T} \} / {Δ}_{F} ⌉} ⌋ + 1 ) \cdot {τ}_{i}^{T} mod {Δ}_{T} ) / {Δ}_{T} ⌋ , 0 \}$$

N represents the sequence length of the root sequence, Δ_{T} represents the maximum round-trip time, and Δ_{F} represents the maximum Doppler frequency shift. Optionally, the quantity

$${\overline{k}}_{i}^{T}$$

of delay-domain near-end residual cyclic shifts is less than the quantity

$${k}_{i}^{T}$$

of delay-domain complete cyclic shifts, an operator └·┘ represents rounding down, and an operator ┌·┐ represents rounding up.

### [Quantity

$${\overline{l}}_{i}^{T}$$

### Of Doppler-Domain Near End Residual Cyclic Shifts]

In a design, the communication apparatus determines the quantity

$${\overline{l}}_{i}^{T}$$

of Doppler-domain near-end residual cyclic shifts based on the coordinates

$$〈 {τ}_{i}^{T} , {ν}_{i}^{T} 〉$$

of the delay-domain cyclic shift reference point and the quantity

$${l}_{i}^{T}$$

of Doppler-domain complete cyclic shifts. In an implementation, the quantity

$${\overline{l}}_{i}^{T}$$

of Doppler-domain near-end residual cyclic shift satisfies:

$${\overline{l}}_{i}^{T} = {l}_{i}^{T} - ⌈ min \{ {ν}_{i}^{T} , N - {ν}_{i}^{T} \} / {Δ}_{F} ⌉ \cdot ⌊ \frac{{l}_{i}^{T}}{⌈ min \{ {ν}_{i}^{T} , N - {ν}_{i}^{T} \} / {Δ}_{F} ⌉} ⌋$$

N represents the sequence length of the root sequence, Δ_{F} represents the maximum Doppler frequency shift, an operator └·┘ represents rounding down, and an operator ┌·┐ represents rounding up.

### [Quantity

$${{k}^{\overline{\_}}}_{i}^{T}$$

### Of Delay-Domain Far-End Residual Cyclic Shifts]

In a design, the communication apparatus determines the quantity

$${{k}^{\overline{\_}}}_{i}^{T}$$

of delay-domain far-end residual cyclic shifts based on the coordinates

$$〈 {τ}_{i}^{T} , {ν}_{i}^{T} 〉$$

of the delay-domain cyclic shift reference point, the restriction coordinates

$$〈 {\overline{τ}}_{i}^{T} , {\overline{ν}}_{i}^{T} 〉 ,$$

and the quantity

$${l}_{i}^{T}$$

of Doppler-domain complete cyclic shifts. In an implementation, the quantity

$${\overline{\overline{k}}}_{i}^{T}$$

of delay-domain far-end residual cyclic shifts satisfies:

$${\overline{\overline{k}}}_{i}^{T} = max \{ ⌊ ( {\overline{τ}}_{i}^{T} - ⌊ \frac{{d}_{i}^{T} - min \{ {\overline{v}}_{i}^{T} , N - {\overline{v}}_{i}^{T} \}}{min \{ {v}_{i}^{T} , N - {v}_{i}^{T} \}} ⌋ \cdot {τ}_{i}^{T} + ( ⌊ \frac{2 {l}_{i}^{T} - ⌊ ( {d}_{i}^{T} + min \{ {v}_{i}^{T} , N - {v}_{i}^{T} \} ) / {Δ}_{F} ⌋}{⌈ min \{ {v}_{i}^{T} , N - {v}_{i}^{T} \} / {Δ}_{F} ⌉} ⌋ + 1 ) \cdot {τ}_{i}^{T} mod {Δ}_{T} ) / {Δ}_{T} ⌋ , 0 \}$$

N represents the sequence length of the root sequence, Δ_{T} represents the maximum round-trip time, and Δ_{F} represents the maximum Doppler frequency shift. Optionally, the quantity

$${\overline{\overline{k}}}_{i}^{T}$$

of delay-domain tar-end residual cyclic shifts is less than or equal to the quantity

$${\overline{k}}_{i}^{T}$$

of delay-domain near-end residual cyclic shifts, an operator └·┘ represents rounding down, and an operator ┌·┐ represents rounding up.

### [Quantity

$${\overline{\overline{l}}}_{i}^{T}$$

### Of Doppler-Domain Rai-End Residual Cyclic Shifts]

In a design, the communication apparatus determines the quantity

$${\overline{\overline{l}}}_{i}^{T}$$

of Doppler-domain far-end residual cyclic shifts based on the coordinates

$$〈 {τ}_{i}^{T} , {v}_{i}^{T} 〉$$

of the delay-domain cyclic shift reference point, the quantity

$${l}_{i}^{T}$$

of Doppler-domain complete cyclic shifts, and the quantity

$${\overline{l}}_{i}^{T}$$

of Doppler-domain near-end residual cyclic shifts. In an implementation, the quantity

$${\overline{\overline{l}}}_{i}^{T}$$

of Doppler-domain far-end residual cyclic shifts satisfies:

$${\overline{\overline{l}}}_{i}^{T} = ⌊ ( {d}_{i}^{T} + min \{ {v}_{i}^{T} , N - {v}_{i}^{T} \} ) / {Δ}_{F} ⌋ - {l}_{i}^{T} - {\overline{l}}_{i}^{T}$$

N represents the sequence length of the root sequence, Δ_{F} represents the maximum Doppler frequency shift, and an operator └·┘ represents rounding down.

### [Quantity of Cyclic Shifts Corresponding to the Doppler-Domain Cyclic Shift Reference Point]

The Doppler-domain cyclic shift reference point includes one or more cyclic shift reference points. For any cyclic shift reference point in the Doppler-domain cyclic shift reference point, coordinates of the cyclic shift reference point may be represented as

$$〈 {τ}_{i}^{F} , {v}_{i}^{F} 〉 .$$

For ease of description, in the following description, the coordinates

$$〈 {τ}_{i}^{F} , {v}_{i}^{F} 〉$$

of the Doppler-domain cyclic shift reference point are used for description.

In a design, the quantity

$${Ω}_{i}^{F}$$

of cyclic shifts corresponding to the Doppler-domain cyclic shift reference point satisfies:

$${Ω}_{i}^{F} = {l}_{i}^{F} \cdot {k}_{i}^{F} + {\overline{l}}_{i}^{F} \cdot {\overline{k}}_{i}^{F} + {\overline{\overline{l}}}_{i}^{F} \cdot {\overline{\overline{k}}}_{i}^{F} {l}_{i}^{F}$$

represents a quantity of Doppler-domain complete cyclic shifts,

$${k}_{i}^{F}$$

represents a quantity of delay-domain complete cyclic shifts,

$${\overline{l}}_{i}^{F}$$

represents a quantity of Doppler-domain near-end residual cyclic shifts,

$${\overline{k}}_{i}^{F}$$

represents a quantity of delay-domain near-end residual cyclic shifts,

$${{l}^{=}}_{i}^{F}$$

represents a quantity of Doppler-domain far-end residual cyclic shifts,

$${{k}^{=}}_{i}^{F}$$

represents a quantity of delay-domain far-end residual cyclic shifts, and a value range of i is 1≤i≤| [symbol] |.

For example, when N=139, u=25, Δ_{T}×Δ_{F}=2×3, coordinates of a 2^{nd} cyclic shift reference point in the Doppler-domain cyclic shift reference point are

$$〈 {τ}_{2}^{F} , {v}_{2}^{F} 〉 = 〈 6 , 11 〉 .$$

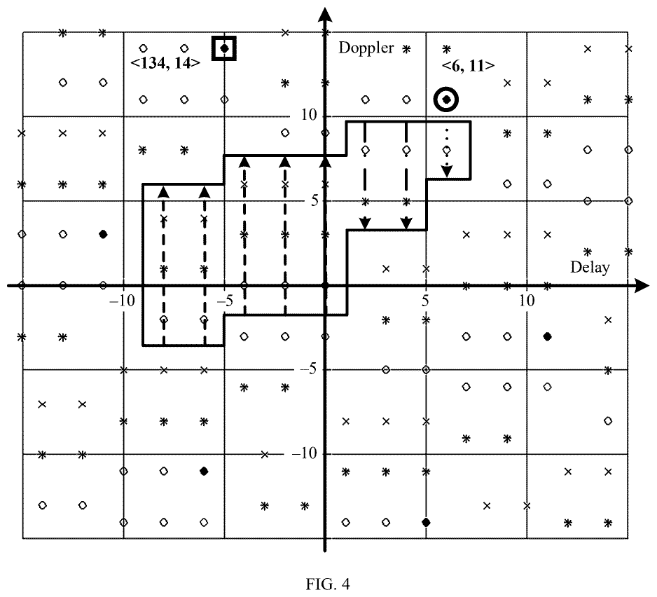

As shown in FIG. 4, restriction coordinates are

$$〈 {\overline{τ}}_{2}^{F} , {\overline{v}}_{2}^{F} 〉 = 〈 134 , 14 〉 ,$$

a delay spacing is

$${d}_{2}^{F} = 11 ,$$

a quantity of delay-domain complete cyclic shifts is

$${k}_{2}^{F} = 5 ,$$

a quantity of Doppler-domain complete cyclic shifts is

$${l}_{2}^{F} = 3 ,$$

a quantity of delay-domain near-end residual cyclic shifts is

$${\overline{k}}_{2}^{F} = 2 ,$$

a quantity of Doppler-domain near-end residual cyclic shifts is

$${\overline{l}}_{2}^{F} = 2 ,$$

a quantity of delay-domain far-end residual cyclic shifts is

$${{k}^{=}}_{2}^{F} = 1 ,$$

and a quantity of Doppler-domain far-end residual cyclic shifts is

$${{l}^{=}}_{2}^{F} = 1.$$

A quantity of cyclic shifts corresponding to a Doppler-domain cyclic shift reference point whose coordinates are

$$〈 {τ}_{2}^{F} , {v}_{2}^{F} 〉 is {Ω}_{i}^{F} = {l}_{2}^{F} \cdot {k}_{2}^{F} + {\overline{l}}_{2}^{F} \cdot {\overline{k}}_{2}^{F} + {{l}^{=}}_{2}^{F} \cdot {{k}^{=}}_{2}^{F} = 3 \cdot 5 + 2 \cdot 2 + 1 \cdot 1 = 20.$$

### [Quantity

$${l}_{i}^{F}$$

### Of Doppler-Domain Complete Cyclic Shifts]

In a design, the communication apparatus may determine the quantity

$${l}_{i}^{F}$$

of Doppler-domain complete cyclic shifts based on the coordinates

$$〈 {τ}_{i}^{F} , {v}_{i}^{F} 〉$$

of the Doppler-domain cyclic shift reference point. In an implementation, the quantity

$${l}_{i}^{F}$$

of Doppler-domain complete cyclic shifts satisfies:

$${l}_{i}^{F} = ⌊ {v}_{i}^{F} / {Δ}_{F} ⌋$$

Δ_{F} represents the maximum Doppler frequency shift, and an operator └·┘ represents rounding down.

### [Quantity

$${k}_{i}^{F}$$

### Of Delay-Domain Complete Cyclic Shifts]

In a design, the communication apparatus determines restriction coordinates

$$〈 {\overline{τ}}_{i}^{F} , {\overline{v}}_{i}^{F} 〉$$

based on the coordinates

$$〈 {τ}_{i}^{F} , {v}_{i}^{F} 〉$$

of the Doppler-domain cyclic shift reference point. In an implementation, the restriction coordinates

$$〈 {\overline{τ}}_{i}^{F} , {\overline{v}}_{i}^{F} 〉$$

satisfy:

$$\{ \text{} \begin{matrix}{\overline{v}}_{i}^{F} = {min}_{τ ∈ \{ 1 , 2 , … , max \{ {Δ}_{T} - 1 , min \{ {τ}_{i}^{F} , N - {τ}_{i}^{F} \} - 1 \} \}} \{ sgn ( {τ}_{i}^{F} - N / 2 ) u τ mod N \} \\ {\overline{τ}}_{i}^{F} = {u}^{- 1} {\overline{v}}_{i}^{F} mod N\end{matrix}$$

N represents the sequence length of the root sequence, u represents the root sequence number, Δ_{T} represents the maximum round-trip time, and an operator (·)⁻¹ represents a multiplicative inverse.

The communication apparatus determines a delay spacing

$${d}_{i}^{F}$$

based on the coordinates

$$〈 {τ}_{i}^{F} , {v}_{i}^{F} 〉$$

of the Doppler-domain cyclic shift reference point and the restriction coordinates

$$〈 {\overline{τ}}_{i}^{F} , {\overline{v}}_{i}^{F} 〉 .$$

In an implementation, the delay spacing

$${d}_{i}^{F}$$

satisfies:

$${d}_{i}^{F} = min \{ d \vert {v}_{i}^{F} - ( ⌊ \frac{d / {Δ}_{T}}{⌈ min \{ {τ}_{i}^{F} , N - {τ}_{i}^{F} \} / {Δ}_{T} ⌉} ⌋ + 1 ) \cdot {v}_{i}^{F} mod {Δ}_{F} \geq {\overline{v}}_{i}^{F} - ⌊ \frac{d - min \{ {\overline{τ}}_{i}^{F} , N - {\overline{τ}}_{i}^{F} \}}{min \{ {τ}_{i}^{F} , N - {τ}_{i}^{F} \}} ⌋ \cdot {v}_{i}^{F} \}$$

N represents the sequence length of the root sequence, Δ_{T} represents the maximum round-trip time, Δ_{F} represents the maximum Doppler frequency shift, an operator └·┘ represents rounding down, and an operator ┌·┐ represents rounding up.

The communication apparatus determines the quantity

$${k}_{i}^{F}$$

of delay-domain complete cyclic shifts based on the delay spacing

$${d}_{i}^{F} .$$

In an implementation, the quantity

$${k}_{i}^{F}$$

of delay-domain complete cyclic shifts satisfies:

$${k}_{i}^{F} = ⌊ {d}_{i}^{F} / {Δ}_{T} ⌋$$

Δ_{T} represents the maximum round-trip time, and an operator └·┘ represents rounding down.

### [Quantity

$${\overline{l}}_{i}^{F}$$

### Of Doppler-Domain Near-End Residual Cyclic Shifts]

In a design, the communication apparatus determines the quantity

$${\overline{l}}_{i}^{F}$$

of Doppler-domain near-end residual cyclic shifts based on the coordinates

$$〈 {τ}_{i}^{F} , {ν}_{i}^{F} 〉$$

of the Doppler-domain cyclic shift reference point and the quantity

$${k}_{i}^{F}$$

of delay-domain complete cyclic shifts. In an implementation, the quantity

$${\overline{l}}_{i}^{F}$$

of Doppler-domain near-end residual cyclic shifts satisfies:

$${\overline{l}}_{i}^{F} = max \{ ⌊ ( {\overline{ν}}_{i}^{F} - ⌊ \frac{{d}_{i}^{F} - min \{ {\overline{τ}}_{i}^{F} , N - {\overline{τ}}_{i}^{F} \}}{min \{ {τ}_{i}^{F} , N - {τ}_{i}^{F} \}} ⌋ \cdot {ν}_{i}^{F} + ( ⌊ \frac{{k}_{i}^{F} - 1}{⌈ min \{ {τ}_{i}^{F} , N - {τ}_{i}^{F} \} / {Δ}_{T} ⌉} ⌋ + 1 ) \cdot {ν}_{i}^{F} mod {Δ}_{F} ) / {Δ}_{F} ⌋ , 0 \}$$

N represents the sequence length of the root sequence, Δ_{T} represents the maximum round-trip time, and Δ_{F} represents the maximum Doppler frequency shift. Optionally, the quantity

$${\overline{l}}_{i}^{F}$$

of Doppler-domain near-end residual cyclic shifts is less than the quantity

$${l}_{i}^{F}$$

of Doppler-domain complete cyclic shifts, an operator └·┘ represents rounding down, and an operator ┌·┐ represents rounding up.

### [Quantity

$${\overline{k}}_{i}^{F}$$

### Of Delay-Domain Near-End Residual Cyclic Shifts]

In a design, the communication apparatus determines the quantity

$${\overline{k}}_{i}^{F}$$

of delay-domain near-end residual cyclic shifts based on the coordinates

$$〈 {τ}_{i}^{F} , {ν}_{i}^{F} 〉$$

of the Doppler-domain cyclic shift reference point and the quantity

$${k}_{i}^{F}$$

of delay-domain complete cyclic shifts. In an implementation, the quantity

$${\overline{k}}_{i}^{F}$$

of delay-domain near-end residual cyclic shifts satisfies:

$${\overline{k}}_{i}^{F} = {k}_{i}^{F} - ⌈ min \{ {τ}_{i}^{F} , N - {τ}_{i}^{F} \} / {Δ}_{T} ⌉ . ⌊ \frac{{k}_{i}^{F}}{⌈ min \{ {τ}_{i}^{F} , N - {τ}_{i}^{F} \} / {Δ}_{T} ⌉} ⌋$$

N represents the sequence length of the root sequence, Δ_{T} represents the maximum round-trip time, an operator └·┘ represents rounding down, and an operator ┌·┐ represents rounding up.

### [Quantity

$${{l}^{=}}_{i}^{F}$$

### Of Doppler-Domain Far-End Residual Cyclic Shifts]

In a design, the communication apparatus determines the quantity

$${{l}^{=}}_{i}^{F}$$

of Doppler-domain far-end residual cyclic shifts based on the coordinates

$$〈 {τ}_{i}^{F} , {v}_{i}^{F} 〉$$

of the Doppler-domain cyclic shift reference point, the restriction coordinates

$$〈 {\overline{τ}}_{i}^{F} , {\overline{v}}_{i}^{F} 〉 ,$$

and the quantity

$${k}_{i}^{F}$$

of delay-domain complete cyclic shifts. In an implementation, the quantity

$${{l}^{=}}_{i}^{F}$$

of Doppler-domain far-end residual cyclic shifts satisfies:

$${{l}^{=}}_{i}^{F} = max \{ ⌊ ( {\overline{v}}_{i}^{F} - ⌊ \frac{{d}_{i}^{F} - min \{ {\overline{τ}}_{i}^{F} , N - {\overline{τ}}_{i}^{F} \}}{min \{ {τ}_{i}^{F} , N - {τ}_{i}^{F} \}} ⌋ \cdot {v}_{i}^{F} + ( ⌊ \frac{2 {k}_{i}^{F} - ⌊ ( {d}_{i}^{F} + min \{ {τ}_{i}^{F} , N - {τ}_{i}^{F} \} ) / {Δ}_{T} ⌋}{⌈ min \{ {τ}_{i}^{F} , N - {τ}_{i}^{F} \} / {Δ}_{T} ⌉} ⌋ + 1 ) \cdot {v}_{i}^{F} mod {Δ}_{F} ) / {Δ}_{F} ⌋ , 0 \}$$

N represents the sequence length of the root sequence, Δ_{T} represents the maximum round-trip time, and Δ_{F} represents the maximum Doppler frequency shift. Optionally, the quantity

$${{l}^{=}}_{i}^{F}$$

of Doppler-domain far-end residual cyclic shifts is less than or equal to the quantity

$${\overline{l}}_{i}^{F}$$

of Doppler-domain near-end residual cyclic shifts, an operator ┌·┐ represents rounding down, and an operator ┌·┐ represents rounding up.

### [Quantity

$${{k}^{=}}_{i}^{F}$$

### Of Delay-Domain-Far-End Residual Cyclic Shifts]

In a design, the communication apparatus determines the quantity

$${{k}^{=}}_{i}^{F}$$

of delay-domain far-end residual cyclic shifts based on the coordinates

$$〈 {τ}_{i}^{F} , {v}_{i}^{F} 〉$$

of the Doppler-domain cyclic shift reference point, the quantity

$${k}_{i}^{F}$$

of delay-domain complete cyclic shifts, and the quantity

$${\overline{k}}_{i}^{F}$$

of delay-domain near-end residual cyclic shifts. In an implementation, the quantity

$${\overline{\overline{k}}}_{i}^{F}$$

of delay-domain far-end residual cyclic shifts satisfies:

$${\overline{\overline{k}}}_{i}^{F} = ⌊ ( {d}_{i}^{F} + min \{ {τ}_{i}^{F} , N - {τ}_{i}^{F} \} ) / {Δ}_{T} ⌋ - {k}_{i}^{F} - {\overline{k}}_{i}^{F}$$

N represents the sequence length of the root sequence, Δ_{T} represents the maximum round-trip time, and an operator └·┘ represents rounding down.

### [Cyclic Shift of the Root Sequence]

In a design, in step 201, the communication apparatus may determine the cyclic shift of the root sequence based on the cyclic shift reference point of the root sequence. For a process of determining the cyclic shift reference point of the root sequence, refer to the foregoing descriptions.

[Case 1]: The communication apparatus determines the cyclic shift of the root sequence based on the quantity of delay-domain complete cyclic shifts and the quantity of Doppler-domain complete cyclic shifts that correspond to the cyclic shift reference point of the root sequence.

In a design, the communication apparatus determines a delay-domain cyclic shift τᵥ and a Doppler-domain cyclic shift vᵥ based on the quantity of delay-domain complete cyclic shifts and the quantity of Doppler-domain complete cyclic shifts that correspond to the cyclic shift reference point of the root sequence. The communication apparatus determines the cyclic shift Cᵥ of the root sequence based on the delay-domain cyclic shift τᵥ and the Doppler-domain cyclic shift vᵥ, where v represents the index of the cyclic shift of the root sequence, and a value range of v is

$$0 \leq v \leq {Ω}_{⋆}^{†} - 1 .$$

In this embodiment of this disclosure, the cyclic shift reference point of the root sequence may be a delay-domain cyclic shift reference point (†=T) or a Doppler-domain cyclic shift reference point (†=F). Based on different delay-domain cyclic shift reference points and Doppler-domain cyclic shift reference points, expressions corresponding to the delay-domain cyclic shift τᵥ and the Doppler-domain cyclic shift vᵥ are different.

For example, when the cyclic shift reference point of the root sequence is the delay-domain cyclic shift reference point, for example, if the cyclic shift reference point of the root sequence is a ★*th cyclic shift reference point in the delay domain (†=T), the delay-domain cyclic shift

$${τ}_{{k}_{⋆}^{T} \cdot l + k}$$

and the Doppler-domain cyclic shift

$${v}_{{k}_{⋆}^{T} \cdot l + k}$$

satisfy:

$$\{ \begin{matrix}{τ}_{{k}_{⋆}^{T} \cdot l + k} = k {Δ}_{T} - ⌊ \frac{l}{⌈ min \{ {v}_{⋆}^{T} , N - {v}_{⋆}^{T} \} / {Δ}_{F} ⌉} ⌋ \cdot {τ}_{⋆}^{T} mod {Δ}_{T} \\ {v}_{{k}_{⋆}^{T} \cdot l + k} = sgn ( {v}_{⋆}^{T} - N / 2 ) \cdot l {Δ}_{F}\end{matrix}$$

N represents the sequence length of the root sequence, Δ_{T} represents the maximum round-trip time, Δ_{F} represents the maximum Doppler frequency shift,

$$〈 {τ}_{⋆}^{T} , {v}_{⋆}^{T} 〉$$

represents coordinates of the cyclic shift reference point of the root sequence,

$${k}_{⋆}^{T}$$

represents the quantity of delay-domain complete cyclic shifts,

$${l}_{⋆}^{T}$$

represents the quantity of Doppler-domain complete cyclic shifts, value ranges of k and l are

$$\{ 0 \leq k < {k}_{⋆}^{T} , 0 \leq l < {l}_{⋆}^{T} \} ,$$

an operator sgn(·) represents a sign function, an operator └·┘ represents rounding down, and an operator ┌·┐ represents rounding up. It should be noted that, in the foregoing expression,

$${τ}_{{k}_{⋆}^{T} \cdot l + k}$$

is equivalent to the foregoing τᵥ, and

$${v}_{{k}_{⋆}^{T} \cdot l + k}$$

is equivalent to the foregoing vᵥ, that is, the index of the cyclic shift of the root sequence is

$$v = {k}_{⋆}^{T} \cdot l + k .$$

In addition/Alternatively, when the cyclic shift reference point of the root sequence is the Doppler-domain cyclic shift reference point, for example, if the cyclic shift reference point of the root sequence is a ★^{th} cyclic shift reference point in the Doppler domain (†=F), the delay-domain cyclic shift

$${τ}_{{l}_{⋆}^{F} \cdot k + l}$$

and the Doppler-domain cyclic shift

$${v}_{{l}_{⋆}^{F} \cdot k + l}$$

satisfy:

$$\{ \begin{matrix}{τ}_{{l}_{⋆}^{F} \cdot k + l} = sgn ( {τ}_{⋆}^{F} - N / 2 ) \cdot k {Δ}_{T} \\ {v}_{{l}_{⋆}^{F} \cdot k + l} = l {Δ}_{F} - ⌊ \frac{k}{⌈ min \{ {τ}_{⋆}^{F} , N - {τ}_{⋆}^{F} \} / {Δ}_{T} ⌉} ⌋ \cdot {v}_{⋆}^{F} mod {Δ}_{F}\end{matrix}$$

N represents the sequence length of the root sequence, Δ_{T} represents the maximum round-trip time, Δ_{F} represents the maximum Doppler frequency shift,

$$〈 {τ}_{⋆}^{F} , {v}_{⋆}^{F} 〉$$

represents coordinates of the cyclic shift reference point of the root sequence,

$${l}_{⋆}^{F}$$

represents the quantity of Doppler-domain complete cyclic shifts,

$${k}_{⋆}^{F}$$

represents the quantity of delay-domain complete cyclic shifts, value ranges of k and l are

$$\{ 0 \leq k < {k}_{⋆}^{F} , 0 \leq l < {l}_{⋆}^{F} \} ,$$

an operator sgn(·) represents a sign function, an operator └·┘ represents rounding down, and an operator ┌·┐ represents rounding up. It should be noted that, in the foregoing expression,

$${τ}_{{l}_{⋆}^{F} \cdot k + l}$$

is equivalent to the foregoing τᵥ, and

$${v}_{{l}_{⋆}^{F} \cdot k + l}$$

is equivalent to the foregoing vᵥ, that is, the index of the cyclic shift of the root sequence is

$$v = {l}_{⋆}^{F} \cdot k + l .$$

[Case 2]: The communication apparatus determines the cyclic shift of the root sequence based on the quantity of delay-domain complete cyclic shifts, the quantity of Doppler-domain complete cyclic shifts, the quantity of delay-domain near-end residual cyclic shifts, and the quantity of Doppler-domain near-end residual cyclic shifts that correspond to the cyclic shift reference point of the root sequence.

In a design, the communication apparatus determines a delay-domain cyclic shift τᵥ and a Doppler-domain cyclic shift vᵥ based on the quantity of delay-domain complete cyclic shifts, the quantity of Doppler-domain complete cyclic shifts, the quantity of delay-domain near-end residual cyclic shifts, and the quantity of Doppler-domain near-end residual cyclic shifts that correspond to the cyclic shift reference point of the root sequence. The communication apparatus determines the cyclic shift Cᵥ of the root sequence based on the delay-domain cyclic shift τᵥ and the Doppler-domain cyclic shift vᵥ, where v represents the index of the cyclic shift of the root sequence, and a value range of v is

$$0 \leq v \leq {Ω}_{⋆}^{†} - 1 .$$

In this embodiment of this disclosure, the cyclic shift reference point of the root sequence may be a delay-domain cyclic shift reference point (†=T) or a Doppler-domain cyclic shift reference point (†=F). Based on different delay-domain cyclic shift reference points and Doppler-domain cyclic shift reference points, expressions corresponding to the delay-domain cyclic shift τᵥ and the Doppler-domain cyclic shift vᵥ are different.

For example, when the cyclic shift reference point of the root sequence is the delay-domain cyclic shift reference point, for example, if the cyclic shift reference point of the root sequence is a ★*th cyclic shift reference point in the delay domain (†=T), the delay-domain cyclic shift

$${τ}_{{k}_{⋆}^{T} \cdot {l}_{⋆}^{T} + {\overline{k}}_{⋆}^{T} \cdot ( {\overline{l}}_{⋆}^{T} + l ) + {\overline{k}}_{⋆}^{T} - k}$$

and the Doppler-domain cyclic shift

$${v}_{{k}_{⋆}^{T} \cdot {l}_{⋆}^{T} + {\overline{k}}_{⋆}^{T} \cdot ( {\overline{l}}_{⋆}^{T} + l ) + {\overline{k}}_{⋆}^{T} - k}$$

satisfy:

$$\{ \begin{matrix}{τ}_{{k}_{⋆}^{T} \cdot {l}_{⋆}^{T} + {\overline{k}}_{⋆}^{T} \cdot ( {\overline{l}}_{⋆}^{T} + l ) + {\overline{k}}_{⋆}^{T} - k} = {τ}_{⋆}^{T} - k {Δ}_{T} \\ {v}_{{k}_{⋆}^{T} \cdot {l}_{⋆}^{T} + {\overline{k}}_{⋆}^{T} \cdot ( {\overline{l}}_{⋆}^{T} + l ) + {\overline{k}}_{⋆}^{T} - k} = sgn ( {v}_{⋆}^{T} - N / 2 ) \cdot l {Δ}_{F}\end{matrix}$$

N represents the sequence length of the root sequence, Δ_{T} represents the maximum round-trip time, Δ_{F} represents the maximum Doppler frequency shift,

$$〈 {τ}_{⋆}^{T} , {v}_{⋆}^{T} 〉$$

represents the coordinates of the cyclic shift reference point of the root sequence,

$${k}_{⋆}^{T}$$

represents the quantity of delay-domain complete cyclic shifts,

$${l}_{⋆}^{T}$$

represents the quantity of Doppler-domain complete cyclic shifts,

$${\overline{k}}_{⋆}^{T}$$

represents the quantity of delay-domain near-end residual cyclic shifts,

$${\overline{l}}_{⋆}^{T}$$

represents the quantity of Doppler-domain near-end residual cyclic shifts, value ranges of k and

$$l are \{ 0 < k \leq {\overline{k}}_{⋆}^{T} , - {\overline{l}}_{⋆}^{T} \leq l < 0 \} ,$$

and an operator sgn (·) represents a sign function. It should be noted that, in the foregoing expression,

$${τ}_{{k}_{⋆}^{T} \cdot {l}_{⋆}^{T} + {\overline{k}}_{⋆}^{T} \cdot ( {\overline{l}}_{*}^{T} + l ) + {\overline{k}}_{⋆}^{T} - k}$$

is equivalent to the foregoing τᵥ, and

$${v}_{{k}_{⋆}^{T} \cdot {l}_{⋆}^{T} + {\overline{k}}_{⋆}^{T} \cdot ( {\overline{l}}_{*}^{T} + l ) + {\overline{k}}_{⋆}^{T} - k}$$

is equivalent to the foregoing vᵥ, that is, the index of the cyclic shift of the root sequence is

$$v = {k}_{⋆}^{T} \cdot {l}_{⋆}^{T} + {\overline{k}}_{⋆}^{T} \cdot ( {\overline{l}}_{⋆}^{T} + l ) + {\overline{k}}_{⋆}^{T} - k .$$

In addition/Alternatively, when the cyclic shift reference point of the root sequence is the Doppler-domain cyclic shift reference point, for example, when the cyclic shift reference point of the root sequence is a ★*th cyclic shift reference point in the Doppler domain (†=F), the delay-domain cyclic shift

$${τ}_{{l}_{⋆}^{F} \cdot {k}_{⋆}^{F} + {\overline{l}}_{⋆}^{F} \cdot ( {\overline{k}}_{⋆}^{F} + k ) + {\overline{l}}_{⋆}^{F} - l}$$

and the Doppler-domain cyclic shift

$${v}_{{l}_{⋆}^{F} \cdot {k}_{⋆}^{F} + {\overline{l}}_{⋆}^{F} \cdot ( {\overline{k}}_{⋆}^{F} + k ) + {\overline{l}}_{⋆}^{F} - l}$$

satisfy:

$$\{ \begin{matrix}{τ}_{{l}_{⋆}^{F} \cdot {k}_{⋆}^{F} + {\overline{l}}_{⋆}^{F} \cdot ( {\overline{k}}_{⋆}^{F} + k ) + {\overline{l}}_{⋆}^{F} - l} = sgn ( {τ}_{⋆}^{F} - N / 2 ) \cdot k {Δ}_{T} \\ {v}_{{l}_{⋆}^{F} \cdot {k}_{⋆}^{F} + {\overline{l}}_{⋆}^{F} \cdot ( {\overline{k}}_{⋆}^{F} + k ) + {\overline{l}}_{⋆}^{F} - l} = {v}_{⋆}^{F} - l {Δ}_{F}\end{matrix}$$

N represents the sequence length of the root sequence, Δ_{T} represents the maximum round-trip time, Δ_{F} represents the maximum Doppler frequency shift,

$$〈 {τ}_{⋆}^{F} , {v}_{⋆}^{F} 〉$$

represents coordinates of the cyclic shift reference point of the root sequence,

$${l}_{⋆}^{F}$$

represents the quantity of Doppler-domain complete cyclic shifts,

$${k}_{⋆}^{F}$$

represents the quantity of delay-domain complete cyclic shifts,

$${\overline{l}}_{⋆}^{F}$$

represents the quantity of Doppler-domain near-end residual cyclic shifts,

$${\overline{k}}_{⋆}^{F}$$

represents the quantity of delay-domain near-end residual cyclic shifts, value ranges of k and l are

$$\{ - {\overline{k}}_{⋆}^{F} \leq k < 0 , 0 < l \leq {\overline{l}}_{⋆}^{F} \} ,$$

and an operator sgn(·) represents a sign function. It should be noted that, in the foregoing expression,

$${τ}_{{l}_{⋆}^{F} \cdot {k}_{⋆}^{F} + {\overline{l}}_{⋆}^{F} \cdot ( {\overline{k}}_{⋆}^{F} + k ) + {\overline{l}}_{⋆}^{F} - l}$$

is equivalent to the foregoing τᵥ, and

$${v}_{{l}_{⋆}^{F} \cdot {k}_{⋆}^{F} + {\overline{l}}_{⋆}^{F} \cdot ( {\overline{k}}_{⋆}^{F} + k ) + {\overline{l}}_{⋆}^{F} - l}$$

is equivalent to the foregoing vᵥ, that is, the index of the cyclic shift of the root sequence is

$$v = {l}_{⋆}^{F} \cdot {k}_{⋆}^{F} + {\overline{l}}_{⋆}^{F} \cdot ( {\overline{k}}_{⋆}^{F} + k ) + {\overline{l}}_{⋆}^{F} - l .$$

[Case 3]: The communication apparatus determines the cyclic shift of the root sequence based on the quantity of delay-domain complete cyclic shifts, the quantity of Doppler-domain complete cyclic shifts, the quantity of delay-domain near-end residual cyclic shifts, the quantity of Doppler-domain near-end residual cyclic shifts, the quantity of delay-domain far-end residual cyclic shifts, and the quantity of Doppler-domain far-end residual cyclic shifts that correspond to the cyclic shift reference point of the root sequence.

In a design, the communication apparatus determines a delay-domain cyclic shift τᵥ and a Doppler-domain cyclic shift vᵥ based on the quantity of delay-domain complete cyclic shifts, the quantity of Doppler-domain complete cyclic shifts, the quantity of delay-domain near-end residual cyclic shifts, the quantity of Doppler-domain near-end residual cyclic shifts, the quantity of delay-domain far-end residual cyclic shifts, and the quantity of Doppler-domain far-end residual cyclic shifts that correspond to the cyclic shift reference point of the root sequence; and determines the cyclic shift Cᵥ of the root sequence based on the delay-domain cyclic shift τᵥ and the Doppler-domain cyclic shift vᵥ. v represents the index of the cyclic shift of the root sequence, and a value range of v is

$$0 \leq v \leq {Ω}_{⋆}^{†} - 1 .$$

In this embodiment of this disclosure, the cyclic shift reference point of the root sequence may be a delay-domain cyclic shift reference point (†=T) or a Doppler-domain cyclic shift reference point (†=F). Based on different delay-domain cyclic shift reference points and Doppler-domain cyclic shift reference points, expressions corresponding to the delay-domain cyclic shift τᵥ and the Doppler-domain cyclic shift vᵥ are different.

For example, when the cyclic shift reference point of the root sequence is the delay-domain cyclic shift reference point, for example, if the cyclic shift reference point of the root sequence is a ★*th cyclic shift reference point in the delay domain (†=T), the delay-domain cyclic shift

$${τ}_{{k}_{⋆}^{T} \cdot {l}_{⋆}^{T} + {\overline{k}}_{⋆}^{T} \cdot {\overline{l}}_{⋆}^{T} \cdot {{k}^{\overline{\_}}}_{⋆}^{T} \cdot ( {\overline{l}}_{⋆}^{T} + {{l}^{\overline{\_}}}_{⋆}^{T} + l ) + {{k}^{\overline{\_}}}_{⋆}^{T} - k}$$

and the Doppler-domain cyclic shift

$${v}_{{k}_{⋆}^{T} \cdot {l}_{⋆}^{T} + {\overline{k}}_{⋆}^{T} \cdot {\overline{l}}_{⋆}^{T} \cdot {{k}^{\overline{\_}}}_{⋆}^{T} \cdot ( {\overline{l}}_{⋆}^{T} + {{l}^{\overline{\_}}}_{⋆}^{T} + l ) + {{k}^{\overline{\_}}}_{⋆}^{T} - k}$$

satisfy:

$$\{ \begin{matrix}{τ}_{{k}_{⋆}^{T} \cdot {l}_{⋆}^{T} + {\overline{k}}_{⋆}^{T} \cdot {\overline{l}}_{⋆}^{T} \cdot {{k}^{\overline{\_}}}_{⋆}^{T} \cdot ( {\overline{l}}_{⋆}^{T} + {{l}^{\overline{\_}}}_{⋆}^{T} + l ) + {{k}^{\overline{\_}}}_{⋆}^{T} - k} = {τ}_{⋆}^{T} - k {Δ}_{T} \\ {v}_{{k}_{⋆}^{T} \cdot {l}_{⋆}^{T} + {\overline{k}}_{⋆}^{T} \cdot {\overline{l}}_{⋆}^{T} \cdot {{k}^{\overline{\_}}}_{⋆}^{T} \cdot ( {\overline{l}}_{⋆}^{T} + {{l}^{\overline{\_}}}_{⋆}^{T} + l ) + {{k}^{\overline{\_}}}_{⋆}^{T} - k} = sgn ( {v}_{⋆}^{T} - N / 2 ) \cdot l {Δ}_{F}\end{matrix}$$

N represents the sequence length of the root sequence, Δ_{T} represents the maximum round-trip time, Δ_{F} represents the maximum Doppler frequency shift,

$$〈 {τ}_{⋆}^{T} , {v}_{⋆}^{T} 〉$$

represents coordinates of the cyclic shift reference point of the root sequence,

$${k}_{⋆}^{T}$$

represents the quantity of delay-domain complete cyclic shifts,

$${l}_{⋆}^{T}$$

represents the quantity of Doppler-domain complete cyclic shifts,

$${\overline{k}}_{⋆}^{T}$$

represents the quantity of delay-domain near-end residual cyclic shifts,

$${\overline{l}}_{⋆}^{T}$$

represents the quantity of Doppler-domain near-end residual cyclic shifts,

$${{k}^{\overline{\_}}}_{⋆}^{T}$$

represents the quantity of delay-domain far-end residual cyclic shifts,

$${{l}^{=}}_{*}^{T}$$

represents the quantity of Doppler-domain far-end residual cyclic shifts, value ranges of k and l are

$$\{ 0 < k \leq {{k}^{=}}_{*}^{T} , - {\overline{l}}_{*}^{T} - {{l}^{=}}_{*}^{T} \leq l < - {\overline{l}}_{*}^{T} \} ,$$

and an operator sgn(·) represents a sign function. It should be noted that, in the foregoing expression,

$${τ}_{{k}_{*}^{T} \cdot {l}_{*}^{T} + {\overline{k}}_{*}^{T} \cdot {\overline{l}}_{*}^{T} + {{k}^{=}}_{*}^{T} \cdot ( {\overline{l}}_{*}^{T} + {{l}^{=}}_{*}^{T} + l ) + {{k}^{=}}_{*}^{T} - k}$$

is equivalent to the foregoing τᵥ, and

$${v}_{{k}_{*}^{T} \cdot {l}_{*}^{T} + {\overline{k}}_{*}^{T} \cdot {\overline{l}}_{*}^{T} + {{k}^{=}}_{*}^{T} \cdot ( {\overline{l}}_{*}^{T} + {{l}^{=}}_{*}^{T} + l ) + {{k}^{=}}_{*}^{T} - k}$$

is equivalent to the foregoing vᵥ, that is, the index of the cyclic shift of the root sequence is

$$v = {k}_{*}^{T} \cdot {l}_{*}^{T} + {\overline{k}}_{*}^{T} \cdot {\overline{l}}_{*}^{T} + {{k}^{=}}_{*}^{T} \cdot ( {\overline{l}}_{*}^{T} + {{l}^{=}}_{*}^{T} + l ) + {{k}^{=}}_{*}^{T} - k .$$

In addition/Alternatively, when the cyclic shift reference point of the root sequence is the Doppler-domain cyclic shift reference point, for example, when the cyclic shift reference point of the root sequence is a ★*th cyclic shift reference point in the Doppler domain (†=F), the delay-domain cyclic shift

$${τ}_{{l}_{*}^{F} \cdot {k}_{*}^{F} + {\overline{l}}_{*}^{F} \cdot {\overline{k}}_{*}^{F} + {{l}^{=}}_{*}^{F} \cdot ( {\overline{k}}_{*}^{F} + {{k}^{=}}_{*}^{F} + k ) + {{l}^{=}}_{*}^{F} - l}$$

and the Doppler-domain cyclic shift

$${v}_{{l}_{*}^{F} \cdot {k}_{*}^{F} + {\overline{l}}_{*}^{F} \cdot {\overline{k}}_{*}^{F} + {{l}^{=}}_{*}^{F} \cdot ( {\overline{k}}_{*}^{F} + {{k}^{=}}_{*}^{F} + k ) + {{l}^{=}}_{*}^{F} - l}$$

satisfy:

$$\{ \begin{matrix}{τ}_{{l}_{*}^{F} \cdot {k}_{*}^{F} + {\overline{l}}_{*}^{F} \cdot {\overline{k}}_{*}^{F} + {{l}^{=}}_{*}^{F} \cdot ( {\overline{k}}_{*}^{F} + {{k}^{=}}_{*}^{F} + k ) + {{l}^{=}}_{*}^{F} - l} = sgn ( {t}_{*}^{F} - N / 2 ) \cdot {k Δ}_{T} \\ {v}_{{l}_{*}^{F} \cdot {k}_{*}^{F} + {\overline{l}}_{*}^{F} \cdot {\overline{k}}_{*}^{F} + {{l}^{=}}_{*}^{F} \cdot ( {\overline{k}}_{*}^{F} + {{k}^{=}}_{*}^{F} + k ) + {{l}^{=}}_{*}^{F} - l} = {v}_{*}^{F} - {l Δ}_{F}\end{matrix}$$

N represents the sequence length of the root sequence, Δ_{T} represents the maximum round-trip time, Δ_{F} represents the maximum Doppler frequency shift,

$$〈 {τ}_{⋆}^{F} , {v}_{⋆}^{F} 〉$$

represents coordinates of the cyclic shift reference point of the root sequence,

$${l}_{⋆}^{F}$$

represents the quantity of Doppler-domain complete cyclic shifts,

$${k}_{⋆}^{F}$$

represents the quantity or delay-domain complete cyclic shifts,

$${\overline{l}}_{⋆}^{F}$$

represents the quantity of Doppler-domain near-end residual cyclic shifts,

$${\overline{k}}_{⋆}^{F}$$

represents the quantity of delay-domain near-end residual cyclic shifts,

$${{l}^{=}}_{⋆}^{F}$$

represents the quantity of Doppler-domain far-end residual cyclic shifts,

$${{k}^{=}}_{⋆}^{F}$$

represents the quantity of delay-domain far-end residual cyclic shifts, value ranges of k and l are

$$\{ - {\overline{k}}_{★}^{F} - {{k}^{=}}_{★}^{F} \leq k < - {\overline{k}}_{★}^{F} , 0 < l \leq {{l}^{=}}_{★}^{F} \} ,$$

and an operator sgn(·) represents a sign function. It should be noted that, in the foregoing expression,

$${τ}_{{l}_{★}^{F} \cdot {k}_{★}^{F} + {\overline{l}}_{★}^{F} \cdot {\overline{k}}_{★}^{F} + {{l}^{=}}_{★}^{F} \cdot ( {\overline{k}}_{★}^{F} + {{k}^{=}}_{★}^{F} + k ) + {{l}^{=}}_{★}^{F} - l}$$

is equivalent to the foregoing τᵥ, and

$${v}_{{l}_{★}^{F} \cdot {k}_{★}^{F} + {\overline{l}}_{★}^{F} \cdot {\overline{k}}_{★}^{F} + {{l}^{=}}_{★}^{F} \cdot ( {\overline{k}}_{★}^{F} + {{k}^{=}}_{★}^{F} + k ) + {{l}^{=}}_{★}^{F} - l}$$

is equivalent to the foregoing vᵥ, that is, the index of the cyclic shift of the root sequence is

$$v = {l}_{★}^{F} \cdot {k}_{★}^{F} + {\overline{l}}_{★}^{F} \cdot {\overline{k}}_{★}^{F} + {{l}^{=}}_{★}^{F} \cdot ( {\overline{k}}_{★}^{F} + {{k}^{=}}_{★}^{F} + k ) + {{l}^{=}}_{★}^{F} - l .$$

In [Case 1] to [Case 3], the communication apparatus may determine the cyclic shift Cᵥ of the root sequence based on the delay-domain cyclic shift τᵥ and the Doppler-domain cyclic shift vᵥ. The cyclic shift Cᵥ of the root sequence satisfies:

$${C}_{v} = ( {τ}_{v} - {u}^{- 1} {v}_{v} ) mod N$$

N represents the sequence length of the root sequence, u represents the root sequence number, v represents the index of the cyclic shift of the root sequence, τᵥ represents the delay-domain cyclic shift, vᵥ represents the Doppler-domain cyclic shift, an operator (·)⁻¹ represents a multiplicative inverse, and v represents the index of the cyclic shift of the root sequence.

That is, the communication apparatus may substitute the delay-domain cyclic shift τᵥ and the Doppler-domain cyclic shift vᵥ that are obtained in any one of the foregoing Case 1 to Case 3 into the foregoing expression, to obtain the corresponding cyclic shift Cᵥ of the root sequence. In a design, the communication apparatus may obtain a union set of the delay-domain cyclic shifts τᵥ and the Doppler-domain cyclic shifts τᵥ that are respectively obtained in the foregoing Case 1 to Case 3, and substitute each group of the delay-domain cyclic shift τᵥ and the Doppler-domain cyclic shift vᵥ in the set into the foregoing expression of the cyclic shift of the root sequence, to obtain the corresponding cyclic shift Cᵥ of the root sequence. For example, the communication apparatus obtains 15 groups of parameters by using Case 1, and each group of parameters in the 15 groups of parameters includes a delay-domain cyclic shift τᵥ and a Doppler-domain cyclic shift vᵥ. The communication apparatus obtains 4 groups of parameters by using Case 2, and obtains 1 group of parameters by using Case 3. The communication apparatus obtains a union set of the foregoing plurality of groups of parameters to obtain 20 groups of parameters. The communication apparatus separately substitutes delay-domain cyclic shifts τᵥ and Doppler-domain cyclic shifts vᵥ in the 20 groups of parameters into the foregoing expression of the cyclic shift Cᵥ of the root sequence, and the communication apparatus may obtain cyclic shifts Cᵥ of 20 root sequences. Further, the communication apparatus may obtain 20 sequences by substituting the cyclic shifts Cᵥ of the 20 root sequences into the expression of the root sequence, and the 20 sequences may form a cyclic shift sequence. Ambiguity functions of any two sequences in the 20 sequences within the range of the maximum round-trip time and the maximum Doppler frequency shift are equal to zero.

For example, when N=139, u=25, Δ_{T}×Δ_{F}=2×3, the cyclic shift reference point of the root sequence is a delay-domain cyclic shift reference point, the cyclic shift reference point of the root sequence is

$$〈 {τ}_{★}^{†} , {v}_{★}^{†} 〉 = 〈 {τ}_{1}^{T} , {v}_{1}^{T} 〉 = 〈 5 , 125 〉 ,$$

and a corresponding quantity of cyclic shifts is

$${Ω}_{★}^{†} = {Ω}_{1}^{T} = 21 .$$

It should be noted that the quantity of cyclic shifts of the root sequence is consistent with a quantity of subsequently obtained cyclic shifts Cᵥ of the root sequence. That is, if the quantity of cyclic shifts of the root sequence is 21, a quantity of subsequently obtained cyclic shifts Cᵥ of the root sequence is also 21. Further, a finally obtained cyclic shift sequence also includes 21 sequences. Therefore, in this embodiment of this disclosure, the communication apparatus selects, from the delay-domain cyclic shift reference point and the Doppler-domain cyclic shift reference point, a cyclic shift reference point with a largest quantity of cyclic shifts as the cyclic shift reference point of the root sequence, so that a maximum capacity of an obtained cyclic shift sequence can be ensured.

Still using the foregoing example for description, the communication apparatus may separately obtain delay-domain cyclic shifts τᵥ and Doppler-domain cyclic shifts vᵥ according to the descriptions in the foregoing Case 1 to Case 3. The communication apparatus obtains a union set of the delay-domain cyclic shifts τᵥ and the Doppler-domain cyclic shifts vᵥ that are respectively obtained in Case 1 to Case 3, and may obtain 21 groups of delay-domain cyclic shifts τᵥ and Doppler-domain cyclic shifts vᵥ, which may be expressed as:

$$〈 {τ}_{v} , {v}_{v} 〉 ∈ \{ \begin{matrix}〈 0 , 0 〉 , 〈 2 , 0 〉 , 〈 0 , 3 〉 , 〈 2 , 3 〉 , 〈 0 , 6 〉 , 〈 2 , 6 〉 , \\ 〈 0 , 9 〉 , 〈 2 , 9 〉 , 〈 0 , 12 〉 , 〈 2 , 12 〉 , 〈 - 1 , 15 〉 , \\ 〈 1 , 15 〉 , 〈 - 1 , 18 〉 , 〈 1 , 18 〉 , 〈 - 1 , 21 〉 , 〈 1 , 21 〉 , \\ 〈 3 , - 3 〉 , 〈 3 , - 6 〉 , 〈 3 , - 9 〉 , 〈 3 , - 12 〉 , 〈 3 , - 15 〉\end{matrix} \}$$

The communication apparatus substitutes the 21 groups of delay-domain cyclic shifts τᵥ and Doppler-domain cyclic shifts vᵥ into the expression of the cyclic shift Cᵥ of the root sequence, and may obtain values of cyclic shifts Cᵥ of 21 root sequences, which may be expressed as:

$${C}_{v} ∈ \{ \begin{matrix}0 , 2 , 11 , 13 , 22 , 24 , 33 , 35 , \\ 44 , 46 , 54 , 56 , 65 , 67 , 76 , \\ 78 , 131 , 120 , 109 , 98 , 87\end{matrix} \} .$$

### Example 1

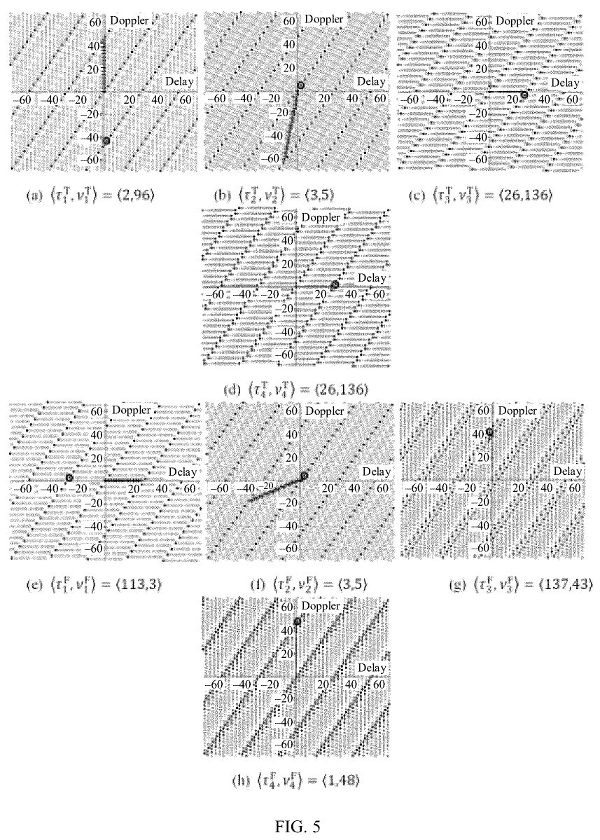

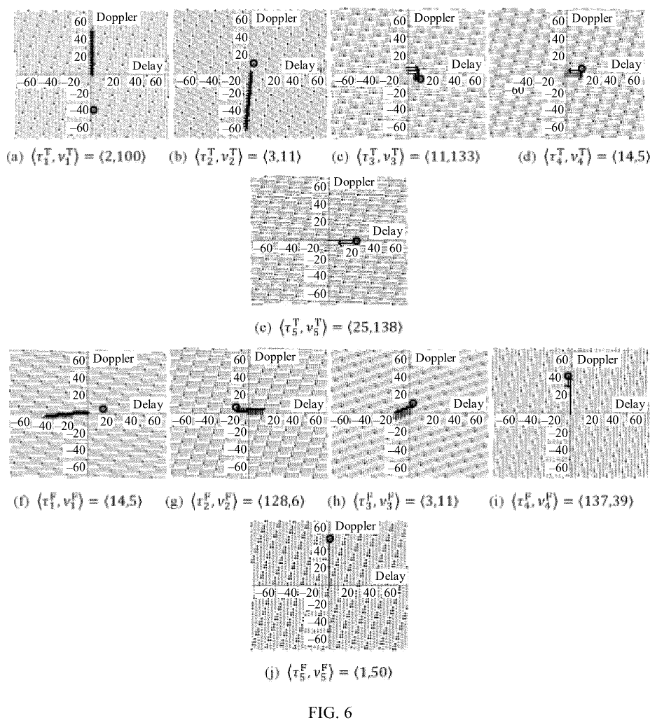

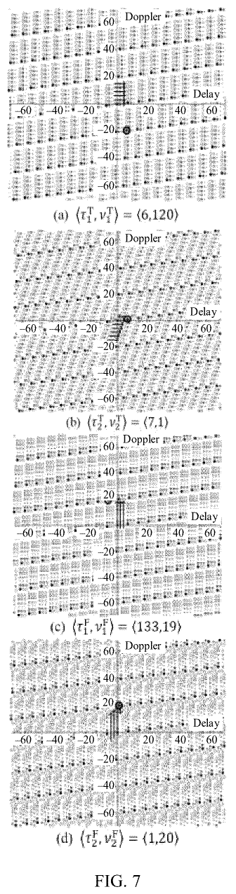

For example, when N=139, u=48, Δ_{T}×Δ_{F}=2×3, as shown in FIG. 5, delay-domain cyclic shift reference points determined by using the method in this embodiment of this disclosure are

$$〈 {τ}_{1}^{T} , {v}_{1}^{T} 〉 = 〈 2 , 96 〉 , 〈 {τ}_{2}^{T} , {v}_{2}^{T} 〉 = 〈 3 , 5 〉 , 〈 {τ}_{3}^{T} , {v}_{3}^{T} 〉 = 〈 26 , 136 〉 , 〈 {τ}_{4}^{T} , {v}_{4}^{T} 〉 = 〈 29 , 2 〉 .$$

Determined Doppler-domain cyclic shift reference points are

$$〈 {τ}_{1}^{F} , {v}_{1}^{F} 〉 = 〈 113 , 3 〉 , 〈 {τ}_{2}^{F} , {v}_{2}^{F} 〉 = 〈 3 , 5 〉 , 〈 {τ}_{3}^{F} , {v}_{3}^{F} 〉 = 〈 137 , 43 〉 , 〈 {τ}_{4}^{F} , {v}_{4}^{F} 〉 = 〈 1 , 48 〉 .$$

Quantities of cyclic shifts corresponding to the delay-domain cyclic shift reference points are respectively

$${Ω}_{1}^{T} = 16 , {Ω}_{2}^{T} = 21 , {Ω}_{3}^{T} = 14 , {Ω}_{4}^{T} = 14 .$$

Quantities of cyclic shifts corresponding to the Doppler-domain cyclic shift reference points are respectively

$${Ω}_{1}^{F} = 14 , {Ω}_{2}^{F} = 20 , {Ω}_{3}^{F} = 16 , {Ω}_{4}^{F} = 16 .$$

Based on a principle of using a cyclic shift reference point with a largest quantity of cyclic shifts as a cyclic shift reference point of the root sequence, the cyclic shift reference point of the root sequence is

$$〈 {τ}_{★}^{†} , {v}_{★}^{†} 〉 = 〈 {τ}_{2}^{T} , {v}_{2}^{T} 〉 = 〈 3 , 5 〉 ,$$

and a quantity of cyclic shifts corresponding to the cyclic shift reference point

$${Ω}_{★}^{†} = {Ω}_{2}^{T} = 21 .$$

In other words, according to the method in this embodiment of this disclosure, the determined cyclic shift sequence includes 21 sequences, and a capacity of the cyclic shift sequence is 21. Alternatively, a description is as follows: cyclic shifts of 21 sequences may be supported by using the method in this embodiment of this disclosure, and cyclic shifts Cᵥ of root sequences corresponding to the cyclic shifts of the 21 sequences are represented as {0,7,13,20,26,33,40,46,53,60,66,73,79,86,93,99,106,113,119,126,132}.

Under a limitation of N=139, u=48, Δ_{T}×Δ_{F}=2×3, in an existing solution, a determined cyclic shift sequence includes 14 sequences. For example, in the existing solution, cyclic shifts of 14 root sequences corresponding to the 14 sequences may be represented as {0,2,4,6,8,10,12,14,16,18,20,22,24,26}.

It can be learned from comparison that, under a same condition, a capacity of a cyclic shift sequence obtained by using the method in this embodiment of this disclosure is greater than a capacity of a cyclic shift sequence obtained in another technology.

### Example 2

When N=139, u=50, Δ_{T}×Δ_{F}=2×3, as shown in FIG. 6, delay-domain cyclic shift reference points determined by using the method in this embodiment of this disclosure are

$$〈 {τ}_{1}^{T} , {v}_{1}^{T} 〉 = 〈 2 , 100 〉 , 〈 {τ}_{2}^{T} , {v}_{2}^{T} 〉 = 〈 3 , 11 〉 , 〈 {τ}_{3}^{T} , {v}_{3}^{T} 〉 = 〈 11 , 133 〉 ,$$

$$〈 {τ}_{4}^{T} , {v}_{4}^{T} 〉 = 〈 14 , 5 〉 , 〈 {τ}_{5}^{T} , {v}_{5}^{T} 〉 = 〈 25 , 138 〉 .$$

Doppler-domain cyclic shift reference points are

$$〈 {τ}_{1}^{F} , {v}_{1}^{F} 〉 = 〈 14 , 5 〉 , 〈 {τ}_{2}^{F} , {v}_{2}^{F} 〉 = 〈 128 , 6 〉 , 〈 {τ}_{3}^{F} , {v}_{3}^{F} 〉 = 〈 3 , 11 〉 ,$$

$$〈 {τ}_{4}^{F} , {v}_{4}^{F} 〉 = 〈 137 , 39 〉 , 〈 {τ}_{5}^{F} , {v}_{5}^{F} 〉 = 〈 1 , 50 〉 .$$

Quantities of cyclic shifts corresponding to the delay-domain cyclic shift reference points are respectively

$${Ω}_{1}^{T} = 16 , {Ω}_{2}^{T} = 20 , {Ω}_{3}^{T} = 19 , {Ω}_{4}^{T} = 19 , {Ω}_{5}^{T} = 19 .$$

Quantities of cyclic shifts corresponding to the Doppler-domain cyclic shift reference points are respectively

$${Ω}_{1}^{F} = 19 , {Ω}_{2}^{F} = 19 , {Ω}_{3}^{F} = 22 , {Ω}_{4}^{F} = 16 , {Ω}_{5}^{F} = 16.$$

Based on a principle of using a cyclic shift reference point with a largest quantity of cyclic shifts as a cyclic shift reference point of the root sequence, the determined cyclic shift reference point of the root sequence is

$$〈 {τ}_{⋆}^{†} , {v}_{⋆}^{†} 〉 = 〈 {τ}_{3}^{F} , {v}_{3}^{F} 〉 = 〈 3 , 11 〉 ,$$

and a quantity of cyclic shifts corresponding to the cyclic shift reference point is

$${Ω}_{⋆}^{†} = {Ω}_{3}^{F} = 22 .$$

Therefore, according to the solution in this embodiment of this disclosure, the determined cyclic shift sequence includes 22 sequences, and cyclic shifts Cᵥ of root sequences corresponding to the 22 sequences are respectively {0,9,11,19,21,29,31,40,42,52,63,73,75,83,85,94,96,104,106,116,127,137}.

Under a limitation of N=139, u=50, ΔTX Δ_{F}=2×3, a cyclic shift sequence determined by using an existing solution includes 19 sequences. For example, in the existing solution, cyclic shifts of 19 root sequences corresponding to the 19 sequences are represented as {0,2,4,6,8,10,12,14,16,18,20,22,75,77,79,81,83,85,87}.

It can be learned from comparison that, under a same condition, a capacity of a cyclic shift sequence obtained by using the method in this embodiment of this disclosure is greater than a capacity of a cyclic shift sequence obtained in another technology.

### Example 3

For example, when N=139, u=20, Δ_{T}×Δ_{F}=2×3, as shown in FIG. 7, delay-domain cyclic shift reference points determined by using the method in this embodiment of this disclosure are

$$〈 {τ}_{1}^{T} , {v}_{1}^{T} 〉 = 〈 6 , 120 〉 , 〈 {τ}_{2}^{T} , {v}_{2}^{T} 〉 = 〈 7 , 1 〉 .$$

Determined Doppler-domain cyclic shift reference points are

$$〈 {τ}_{1}^{F} , {v}_{1}^{F} 〉 = 〈 133 , 19 〉 , 〈 {τ}_{2}^{F} , {v}_{2}^{F} 〉 = 〈 1 , 20 〉 .$$

Quantities of cyclic shifts corresponding to the delay-domain cyclic shift reference points are respectively

$${Ω}_{1}^{T} = 18 , {Ω}_{2}^{T} = 20.$$

Quantities of cyclic shifts corresponding to the Doppler-domain cyclic shift reference points are respectively

$${Ω}_{1}^{F} = 18 , {Ω}_{2}^{F} = 19.$$

Based on a principle of using a cyclic shift reference point with a largest quantity of cyclic shifts as a cyclic shift reference point of the root sequence, the determined cyclic shift reference point of the root sequence is

$$〈 {τ}_{⋆}^{†} , {v}_{⋆}^{†} 〉 = 〈 {τ}_{2}^{T} , {v}_{2}^{T} 〉 = 〈 7 , 1 〉 ,$$

and a quantity of cyclic shifts corresponding to the cyclic shift reference point is

$${Ω}_{⋆}^{†} = {Ω}_{2}^{T} = 20 .$$

In other words, according to the method in this embodiment of this disclosure, the determined cyclic shift sequence includes 20 sequences, and a capacity of the cyclic shift sequence is 20. Alternatively, a description is as follows: cyclic shifts of 20 sequences may be supported by using the method in this embodiment of this disclosure, and cyclic shifts Cᵥ of root sequences corresponding to the cyclic shifts of the 20 sequences are respectively {0,2,4,20,22,24,40,42,44,60,62,64,80,82,84,100,102,104,121,123}.

Similarly, under a limitation of N=139, u=20,ΔTX Δ_{F}=2×3, in an existing solution, a determined cyclic shift sequence includes 20 sequences. For example, in the existing solution, cyclic shifts of 20 root sequences corresponding to the 20 sequences may be represented as {0,2,4,20,22,24,40,42,44,60,62,64,80,82,84,100,102,104,121,123}.

It can be learned from comparison that, under a same condition, a capacity of a cyclic shift sequence obtained by using the method in this embodiment of this disclosure is equal to a capacity of a cyclic shift sequence obtained in another technology.

### Example 4

For example, when N=139, u=11, ΔTX Δ_{F}=2×3, as shown in FIG. 8, delay-domain cyclic shift reference points determined by using the method in this embodiment of this disclosure are

$$〈 {τ}_{1}^{T} , {v}_{1}^{T} 〉 = 〈 12 , 132 〉 , 〈 {τ}_{2}^{T} , {v}_{2}^{T} 〉 = 〈 13 , 4 〉 , 〈 {τ}_{3}^{T} , {v}_{3}^{T} 〉 = 〈 25 , 136 〉 ,$$

$$〈 {τ}_{4}^{T} , {v}_{4}^{T} 〉 = 〈 {τ}_{4}^{T} , {v}_{4}^{T} 〉 = 〈 38 , 1 〉 .$$

Determined Doppler-domain cyclic shift reference points are

$$〈 {τ}_{1}^{F} , {v}_{1}^{F} 〉 = 〈 114 , 3 〉 , 〈 {τ}_{2}^{F} , {v}_{2}^{F} 〉 = 〈 13 , 4 〉 , 〈 {τ}_{3}^{F} , {v}_{3}^{F} 〉 = 〈 127 , 7 〉 ,$$

$$〈 {τ}_{4}^{F} , {v}_{4}^{F} 〉 = 〈 1 , 11 〉 .$$

Quantities of cyclic shifts corresponding to the delay-domain cyclic shift reference points are respectively

$${Ω}_{1}^{T} = 18 , {Ω}_{2}^{T} = 18 , {Ω}_{3}^{T} = 19 , {Ω}_{4}^{T} = 19.$$

Quantities of cyclic shifts corresponding to the Doppler-domain cyclic shift reference points are respectively

$${Ω}_{1}^{F} = 19 , {Ω}_{2}^{F} = 19 , {Ω}_{3}^{F} = 18 , {Ω}_{4}^{F} = 20.$$

Based on a principle of using a cyclic shift reference point with a largest quantity of cyclic shifts as a cyclic shift reference point of the root sequence, the cyclic shift reference point of the root sequence is

$$〈 {τ}_{*}^{†} , {v}_{*}^{†} 〉 = 〈 {τ}_{4}^{F} , {v}_{4}^{F} 〉 = 〈 1 , 11 〉 ,$$

and a quantity of cyclic shifts corresponding to the cyclic shift reference point is

$${Ω}_{*}^{†} = {Ω}_{4}^{F} = 20.$$

In other words, according to the method in this embodiment of this disclosure, the determined cyclic shift sequence includes 20 sequences, and a capacity of the cyclic shift sequence is 20. Alternatively, a description is as follows: cyclic shifts of 20 sequences may be supported by using the method in this embodiment of this disclosure, and cyclic shifts Cᵥ of root sequences corresponding to the 20 sequences are respectively {0,3,9,18,25,34,43,50,59,68,74,83,90,92,99,108,115,117,124,133}.

Similarly, under a limitation of N=139, u=11, Δ_{T}×Δ_{F}=2×3, in an existing solution, a determined cyclic shift sequence includes 19 sequences. For example, in the existing solution, cyclic shifts of 19 root sequences corresponding to the 19 sequences may be represented as {0,2,4,6,8,10,12,14,16,18,20,22,24,26,28,30,32,34,36}.

It can be learned from comparison that, under a same condition, a capacity of a cyclic shift sequence obtained by using the method in this embodiment of this disclosure is greater than a capacity of a cyclic shift sequence obtained in another technology.

Optionally, the method in the procedure in FIG. 2 further includes: the communication apparatus determines a first sequence from a sequence set, where the sequence set includes cyclic shift sequences of one or more root sequences; and the communication apparatus outputs the first sequence. For example, the communication apparatus may determine the sequence set based on the cyclic shift sequences of the one or more root sequences. For example, the sequence set includes 64 sequences. The communication apparatus determines the first sequence from the sequence set. There are one or more first sequences. For example, the communication apparatus uses the first sequence as a random-access preamble. The communication apparatus outputs the first sequence, and performs random access by using the first sequence. Alternatively, the communication apparatus may use the first sequence in a sensing scenario, and the communication apparatus outputs the first sequence, and uses the first sequence as a sensing signal. The sensing includes but is not limited to identifying a target object and/or positioning a target object. Positioning the target object includes at least one of the following: determining a distance from the target object, a moving speed of the target object, a moving angle of the target object, or the like.

In a design, the communication apparatus in the procedure in FIG. 2 may be a terminal, or a chip, a circuit, or the like used in the terminal. The terminal may determine the cyclic shift sequence of the root sequence by using the method in the procedure in FIG. 2, for example, based on the sequence length of the root sequence, the root sequence number, the maximum round-trip time, and the maximum Doppler frequency shift. The determined cyclic shift sequence may be used in a scenario such as random access or sensing. This is not limited. For example, in a random-access scenario, the terminal may construct a random-access preamble by using the cyclic shift sequence. For example, the cyclic shift sequence determined in step 202 may be used to construct 64 random access preambles. The 64 random access preamble may include a cyclic shift sequence of one root sequence, cyclic shift sequences of a plurality of root sequences, or the like. This is not limited. In a design, the terminal may select one random access preamble from the 64 random access preambles, and send the selected random-access preamble to an access network device. In a design, the terminal may communicate with the access network device by using a plurality of beams. Different beams are corresponding to different sequence sets, and random-access preambles in different sequence sets may indicate different beam directions. In other words, when the terminal communicates with the access network device by using a plurality of beams, the terminal selects a plurality of random-access preambles corresponding to the plurality of beams, and sends corresponding random-access preambles on different beams. For example, the terminal sends one random access preamble to the access network device. When receiving the random-access preamble, the access network device may perform correlation processing on the random-access preamble and a locally generated sequence. If the correlation processing succeeds, it is considered that synchronization between the terminal and the access network device succeeds. The access network device may determine a location (related to a speed of the terminal) and/or a moving speed (related to a Doppler frequency shift of the terminal) of the terminal based on the random-access preamble, to determine a timing advance (TA) and/or a carrier offset. The access network device may send a message 2 to the terminal based on the TA and/or the carrier offset. It may be understood that, in a coverage area of the access network device, a plurality of terminals may simultaneously perform random access in one cell. In other words, in a radius of one cell, a plurality of terminals may simultaneously send random access preambles to the access network device. In the procedure in FIG. 2, ambiguity functions of cyclic shift sequences constructed from a same root sequence within the range of the maximum round-trip time and the maximum Doppler frequency shift are equal to zero, and ambiguity functions of cyclic shift sequences constructed from different root sequences within the range of the maximum round-trip time and the maximum Doppler frequency shift are equal to a square root of a sequence length. Therefore, cyclic shift sequences of a same root sequence are preferentially traversed, and cyclic shift sequences of different root sequences are introduced on this basis to form a sequence set of 64 random access preambles, so that mutual interference between random access preambles of different terminals can be avoided to a maximum extent. Alternatively, the terminal may use the cyclic shift sequences determined in the procedure in FIG. 2 for sensing. For example, the terminal may send a sensing signal. The sensing signal arrives at a target object. After the target object reflects the sensing signal, the terminal may receive the reflected sensing signal, and analyze the received sensing signal, to recognize the target object, position the target object, and/or the like. For example, the terminal may select one cyclic shift sequence from the cyclic shift sequences determined in the procedure in FIG. 2 as a sensing signal.

In another design, the communication apparatus in the procedure in FIG. 2 may be an access network device, or a chip, a circuit, or the like used in the access network device. The access network device may determine the cyclic shift sequence of the root sequence by using the method in the procedure in FIG. 2, for example, based on the sequence length of the root sequence, the root sequence number, the maximum round-trip time, and the maximum Doppler frequency shift. The determined cyclic shift sequence may be used in a scenario such as random access or sensing. This is not limited. For example, in a random-access scenario, the access network device may construct a random-access preamble by using the method in the procedure in FIG. 2. For example, the cyclic shift sequence determined in step 202 may be used to construct 64 random access preambles. Similarly, the 64 random access preambles may include a cyclic shift sequence of one root sequence, cyclic shift sequences of a plurality of root sequences, or the like. This is not limited. Optionally, the access network device may configure the 64 constructed random-access preambles for the terminal. The terminal selects one or more random access preambles from the 64 random access preambles configured by the access network device, for random access and the like. Alternatively, the access network device and the terminal may separately determine a cyclic shift sequence by using the method in the procedure in FIG. 2, and construct 64 random access preambles by using the determined cyclic shift sequence. The terminal selects one random access preamble from the 64 random access preambles determined by the terminal, and sends the selected random-access preamble to the access network device. The access network device may perform related processing on the random-access preamble received from the terminal and any one of the 64 locally constructed random-access preambles. If a preset threshold is exceeded, it is considered that synchronization of the terminal succeeds. Alternatively, the access network device may use the cyclic shift sequences determined in the procedure in FIG. 2 for sensing or the like. In addition to the foregoing terminal, the access network device may also be configured to perform sensing. For example, the access network device may determine the cyclic shift sequence by using the procedure in FIG. 2. The access network device selects a sequence from the determined cyclic shift sequence as a sensing signal, and may recognize a target object, position the target object, and/or the like by sending the sensing signal.

It should be noted that in embodiments of this disclosure:
1. Appropriate modifications to the cyclic shift method for a root sequence provided in embodiments of this disclosure also fall within the protection scope of embodiments of this disclosure. For example, the cyclic shift method for a root sequence provided in embodiments of this disclosure is appropriately modified, but a quantity of cyclic shifts of the root sequence determined by using a modified method is the same as a quantity of cyclic shifts of the root sequence determined by using the method in embodiments of this disclosure. The modification also falls within the protection scope of embodiments of this disclosure.
For example, when N=139, u=25, Δ_{T}×Δ_{F}=2×3, a cyclic shift of a root sequence is further provided:

$${C}_{v} ∈ \{ 0 , 2 , 11 , 13 , 22 , 24 , 33 , 35 , 44 , 46 , 54 , 56 , 65 , 67 , 76 , 78 , 130 , 119 , 108 , 98 , 87 \}$$

2. The cyclic shift sequence provided in embodiments of this disclosure is not limited. Subsequent modifications to the cyclic shift sequence provided in embodiments of this disclosure also fall within the protection scope of embodiments of this disclosure. For example, phase shift performed on the cyclic shift sequence provided in embodiments of this disclosure does not change performance of the ambiguity function of the root sequence, and also falls within the protection scope of embodiments of this disclosure. For example, an expression of a cyclic shift sequence is further provided:

$${s}_{u , v} ( n ) = {e}^{- j π [ u ( n + {τ}_{v} ) ( n + {τ}_{v} + 1 ) - 2 {nv}_{v} ] / N}$$

Alternatively, another expression of a cyclic shift sequence is further provided:

$${s}_{u , v} ( n ) = {e}^{- j π [ {un}^{2} + 2 n ( u {τ}_{v} - {v}_{v} ) ] / N}$$

3. In the descriptions of embodiments of this disclosure, an execution sequence of different steps is not limited. In addition, the procedure in FIG. 2 may include fewer steps or more steps than those in the schematic flowchart or the text descriptions. This is not limited.
4. In the descriptions of this disclosure, “at least one” means one or more, and “a plurality of” means two or more. The term “and/or” describes an association relationship of associated objects, and indicates that three relationships may exist. For example, A and/or B may indicate the following three cases: only A exists, both A and B exist, and only B exists. A and B may be singular or plural. In the text descriptions of this disclosure, the character “/” generally represents an “or” relationship between associated objects. “Including at least one of A, B, or C” may represent: including A; including B; including C; including A and B; including A and C; including B and C; or including A, B, and C.
5. Various numbers in embodiments of this disclosure are merely used for differentiation for ease of description, and are not used to limit the scope of embodiments of this disclosure. Sequence numbers of the foregoing processes do not mean a sequence of execution. The sequence of execution of the processes should be determined according to functions and internal logic of the processes.

In the foregoing embodiments provided in this disclosure, the methods provided in embodiments of this disclosure are separately described from a perspective of interaction between the devices. To implement functions in the foregoing method provided in embodiments of this disclosure, the foregoing communication apparatus may include a hardware structure and/or a software module, and the foregoing functions are implemented in a form of a hardware structure, a software module, or a combination of a hardware structure and a software module. Whether a function in the foregoing functions is performed in a manner of a hardware structure, a software module, or a hardware structure and a software module depends on specific applications and design constraints of the technical solutions.

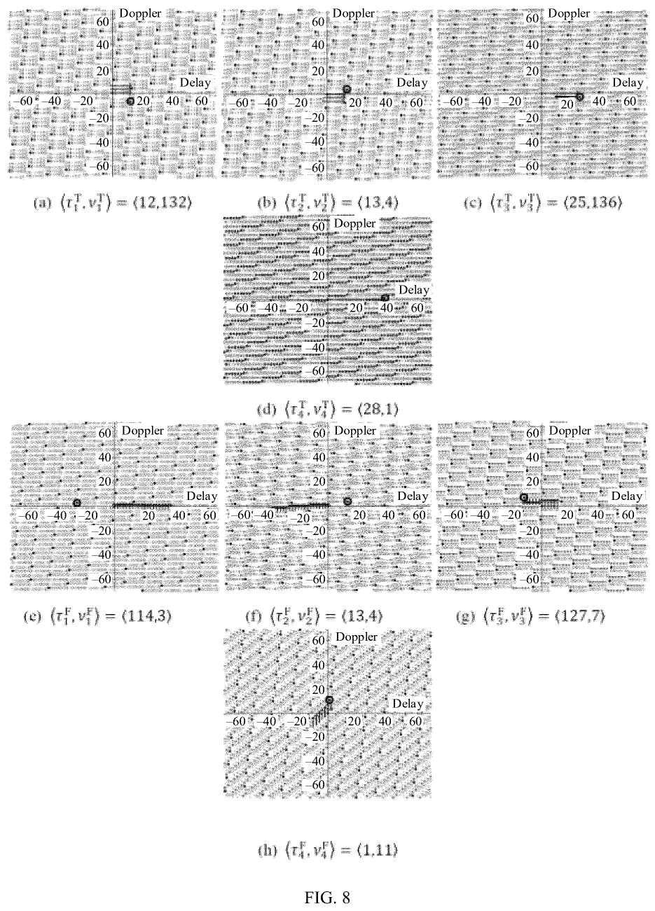

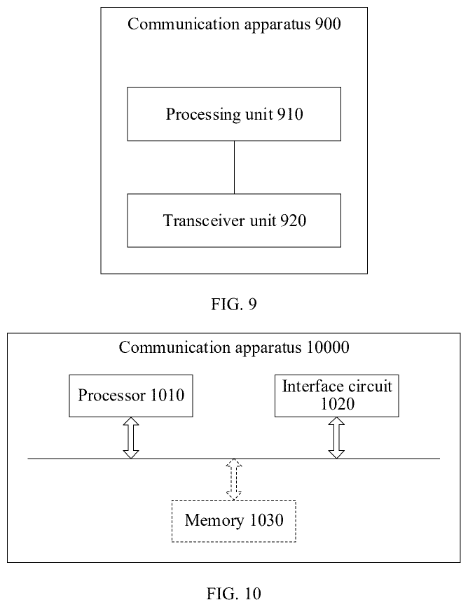

FIG. 9 and FIG. 10 are diagrams of structures of possible apparatuses according to embodiments of this disclosure. These communication apparatuses may implement one or more corresponding functions in the foregoing method embodiments. For example, functions implemented by the foregoing communication apparatus may be implemented. Therefore, beneficial effects of the foregoing method embodiments may be achieved.

As shown in FIG. 9, a communication apparatus 900 includes a processing unit 910 and a transceiver unit 920.

For example, the processing unit 910 may also be referred to as a processor, a processing board, a processing module, a processing apparatus, or the like. The transceiver unit 920 may also be referred to as a transceiver, a transceiver machine, a transceiver module, a transceiver apparatus, a communication unit, or the like. Further, the transceiver unit 920 may include at least one of a sending unit or a receiving unit. The sending unit and the receiving unit may be integrated together, or may be two independent units, or the like.

In a design, the communication apparatus 900 is configured to implement the function of the communication apparatus in FIG. 2. Details are as follows.

The processing unit 910 is configured to: determine a cyclic shift of a root sequence, where the cyclic shift of the root sequence is associated with a sequence length of the root sequence, a root sequence number, a maximum round-trip time, and a maximum Doppler frequency shift; and determine a cyclic shift sequence based on the cyclic shift of the root sequence, where an ambiguity function of the cyclic shift sequence is equal to zero within a range of the maximum round-trip time and the maximum Doppler frequency shift.

Optionally, the transceiver unit 920 is configured to send indication information of the cyclic shift sequence and the like to another communication apparatus.

For more detailed descriptions of the processing unit 910 and the transceiver unit 920, refer to the descriptions in FIG. 2 in the foregoing method embodiments. Details are not described herein again.

It may be understood that, in embodiments of this disclosure, division into the units is an example, and is merely logical function division. During actual implementation, another division manner may be used. In addition, functional units in embodiments of this disclosure may be integrated into one physical device (for example, a processor), or each functional unit may be an independent physical device, or two or more units may be integrated into one unit for implementation. The integrated unit may be implemented in a form of hardware, or implemented in a form of a software functional module, or the like.

FIG. 10 is a diagram of another structure of a communication apparatus 10000 according to an embodiment of this disclosure. For example, the communication apparatus 10000 shown in FIG. 10 may be an implementation of a hardware circuit of the communication apparatus 900 shown in FIG. 9. For ease of description, FIG. 10 shows only a main part of the communication apparatus.

As shown in FIG. 10, the communication apparatus 10000 includes a processor 1010 and an interface circuit 1020. The processor 1010 and the interface circuit 1020 are coupled to each other.

For example, the processor 1010 may be a central processing unit (CPU), or may be another general-purpose processor, a digital signal processor (DSP), an application-specific integrated circuit (ASIC), a field-programmable gate array (FPGA) or another programmable logic device, a transistor logic device, a hardware component, or any combination thereof. The general-purpose processor may be a microprocessor, or may be any other processor, or the like. The interface circuit 1020 may be a transceiver, an input/output circuit, or the like.

Optionally, the communication apparatus 10000 may further include a memory 1030, configured to: store instructions executed by the processor 1010, or store input data required for running instructions by the processor 1010, or store data generated after the processor 1010 runs instructions. For example, the instructions may also be referred to as a computer program, computer program code, or the like.

For example, the memory 1030 may be a random-access memory (RAM), a flash memory, a read-only memory (ROM), a programmable read-only memory (PROM), an erasable programmable read-only memory (EPROM), an electrically erasable programmable read-only memory (EEPROM), a register, a hard disk, a removable hard disk, a compact-disc read-only memory (CD-ROM), or any other form of storage medium well known in the art.

When the communication apparatus 10000 is configured to implement the method of the communication apparatus in FIG. 2, the processor 1010 is configured to implement a function of the processing unit 910, and the interface circuit 1020 is configured to implement a function of the transceiver unit 920.

In a design, the interface circuit 1020 is configured to receive a signal from a communication apparatus other than the communication apparatus 10000 and transmit the signal to the processor 1010, or send a signal from the processor 1010 to a communication apparatus other than the communication apparatus. The processor 1010 is configured to implement a function of the communication apparatus in FIG. 2 by using a logic circuit or executing code instructions.

An embodiment of this disclosure further provides a communication apparatus. The communication apparatus includes a processor and a memory. The processor is coupled to the memory, and the processor is configured to implement a function of the communication apparatus in FIG. 2. For example, the processor may execute instructions in the memory, so that the communication apparatus implements one or more functions in the foregoing method embodiments, for example, a function implemented by the communication apparatus in FIG. 2. An example storage medium is coupled to a processor, so that the processor can read information from the storage medium and can write information into the storage medium. Certainly, the storage medium may alternatively be a part of the processor. The processor and the storage medium may be located in an ASIC. In addition, the ASIC may be located in the communication apparatus in FIG. 2. The processor and the storage medium may alternatively exist in the communication apparatus in FIG. 2 as discrete components.

An embodiment of this disclosure further provides a computer-readable storage medium. The computer-readable storage medium stores instructions, and the instructions may also be referred to as a computer program, computer program code, or the like. The instructions are run on a computer, so that the computer performs a function of the communication apparatus in FIG. 2 in the foregoing method embodiments.

Optionally, the computer may be a general-purpose computer, a dedicated computer, a computer network, a network device, user equipment, or another programmable apparatus. The computer programs or the instructions may be stored in a computer-readable storage medium or may be transmitted from a computer-readable storage medium to another computer-readable storage medium. For example, the computer programs or the instructions may be transmitted from a website, computer, server, or data center to another website, computer, server, or data center in a wired or wireless manner. The computer-readable storage medium may be any usable medium accessible by a computer, or a data storage device such as a server or a data center integrating one or more usable media. The usable medium may be a magnetic medium, for example, a floppy disk, a hard disk drive, or a magnetic tape; or may be an optical medium, for example, a digital video disc; or may be a semiconductor medium, for example, a solid-state drive. The computer-readable storage medium may be a volatile or non-volatile storage medium, or may include two types of storage media: a volatile storage medium and a non-volatile storage medium.

An embodiment of this disclosure further provides a computer program product, including a computer program or instructions. When the computer program or the instructions are run on a computer, the method of the communication apparatus in FIG. 2 is performed. For example, the computer program product includes one or more computer programs or instructions. When the computer programs or the instructions are loaded and executed on a computer, all or some of the procedures or functions of the communication apparatus in FIG. 2 in embodiments of this disclosure are executed.

It may be understood that all or some of the methods in embodiments of this disclosure may be implemented by using software, hardware, firmware, or any other combination. When software is used to implement the methods, all or some of the methods may be implemented in a form of a computer program product.

An embodiment of this disclosure further provides a chip. The chip includes a processor, the processor is coupled to a memory, and the processor is configured to execute a computer program or instructions stored in the memory, so that the chip implements a function of the communication apparatus in FIG. 2.

An embodiment of this disclosure further provides a communication system, including a first communication apparatus and a second communication apparatus.

The first communication apparatus may implement a function of the communication apparatus in FIG. 2. A function that can be implemented by the second communication apparatus is not limited. For a specific structure of the first communication apparatus, refer to the foregoing descriptions, for example, the structure descriptions in FIG. 9 or FIG. 10.

It is clear that a person skilled in the art may make various modifications and variations to this disclosure without departing from the scope of this disclosure. Thus, this disclosure is intended to cover these modifications and variations, provided that they fall within the scope of the claims of this disclosure and their equivalent technologies.

1. A method, comprising:
determining a first cyclic shift of a first root sequence, wherein the first cyclic shift is associated with a sequence length of the first root sequence, a root sequence number, a maximum round-trip time, and a maximum Doppler frequency shift; and
determining, based on the first cyclic shift, a first cyclic shift sequence,
wherein a first ambiguity function of the first cyclic shift sequence is equal to zero within a range of the maximum round-trip time and the maximum Doppler frequency shift.

2. The method of claim 1, wherein determining the first cyclic shift sequence satisfies:
$${s}_{u , v} ( n ) = {e}^{- j π u ( n + {C}_{v} ) ( n + {C}_{v} + 1 ) / N} ,$$
wherein s_{u,v}(n) represents the first cyclic shift sequence, wherein Cᵥ represents the first cyclic shift, wherein N represents the sequence length, wherein N is a prime number, wherein u represents the root sequence number, wherein a first value range of u is 1≤u≤N−1, wherein n represents a symbol index of the first cyclic shift sequence, wherein a second value range of n is 0≤n≤N−1, and wherein v represents an index of the first cyclic shift.

3. The method of claim 1, wherein second ambiguity functions of a second cyclic shift sequence and a third cyclic shift sequence are equal to zero within the range and satisfy:
$$A ( τ , v ) = {\sum }_{n = 0}^{N - 1} {s}_{u , {v}_{1}} ( n ) {s}_{u , {v}_{2}}^{*} ( n - τ ) {e}^{j 2 π nv / N} = \{ \begin{matrix}N , & {v}_{1} = {v}_{2} , τ = 0 , v = 0 \\ 0 , & ( {v}_{1} \neq {v}_{2} ) ⋁ ( τ \neq 0 ) ⋁ ( v \neq 0 )\end{matrix} ,$$
wherein A(τ, v) represents the second ambiguity functions, wherein s_{u,v}_{₁}(n) represents the second cyclic shift sequence, wherein s_{u,v}_{₂}(n) represents the third cyclic shift sequence, wherein Δ_{T} represents the maximum round-trip time, wherein Δ_{F} represents the maximum Doppler frequency shift, wherein N represents the sequence length, wherein u represents the root sequence number, wherein v₁ and v₂ represent indexes of second cyclic shifts of the first root sequence, wherein τ represents a delay coordinate of the first ambiguity function, wherein a first value range of τ is 0≤τ≤Δ_{T}−1, wherein v represents a Doppler coordinate of the first ambiguity function, wherein a second value range of v is 0≤τ≤Δ_{F}−1, wherein a first operator (·)* represents a complex conjugate, and wherein a second operator V represents conditional OR.

4. The method of claim 1, wherein determining the first cyclic shift comprises:
determining, based on a delay-domain cyclic shift reference point and a Doppler-domain cyclic shift reference point, a cyclic shift reference point of the first root sequence; and
determining, based on the cyclic shift reference point, the first cyclic shift.

5. The method of claim 4, wherein a set comprising coordinates of the delay-domain cyclic shift reference point satisfies:
$$S\_T {=}^{△} \{ 〈 τ\_ 1 \hat{} T , v\_ 1 \hat{} T 〉 , 〈 τ\_ 2 \hat{} T , v\_ 2 \hat{} T 〉 , … , 〈 τ\_ \vert 𝒮\_T \vert \hat{} T , v\_ \vert 𝒮\_T \vert \hat{} T 〉 \} = \{ 〈 τ , u τ mod N 〉 \vert min \{ \pm u τ mod N \} < min ⊤ ( n = 1 , 2 , … , τ - 1 ) \{ \pm un mod N \} , τ ∈ \{ Δ\_T , Δ\_T + 1 , … , min ⊤ ( v ∈ \{ \pm 1 , \pm 2 , … , \pm ( Δ\_F - 1 ) \} ) \{ u \hat{} ( - 1 ) v mod N \} \} \} ,$$
wherein [symbol] represents the set, wherein N represents the sequence length, wherein u represents the root sequence number, wherein Δ_{T} represents the maximum round-trip time, wherein Δ_{F} represents the maximum Doppler frequency shift, wherein
$$〈 {τ}_{i}^{T} , {v}_{i}^{T} 〉$$
represents coordinates of an i^{th} delay-domain cyclic shift reference point, wherein a value range of i is 1≤i≤| [symbol] |, wherein a first operator (·)⁻¹ represents a multiplicative inverse, and wherein a second operator |·| represents a cardinality of the set.

6. The method of claim 4, wherein a set comprising coordinates of the Doppler-domain cyclic shift reference point satisfies:
$$S\_F {=}^{△} \{ 〈 τ\_ 1 \hat{} F , v\_ 1 \hat{} F 〉 , 〈 τ\_ 2 \hat{} F , v\_ 2 \hat{} F 〉 , … , 〈 τ\_ \vert 𝒮\_F \vert \hat{} F , v\_ \vert 𝒮\_F \vert \hat{} F 〉 \} = \{ 〈 u \hat{} ( - 1 ) v mod N , v 〉 \vert min \{ \pm u \hat{} ( - 1 ) v mod N \} < min ⊤ ( n = 1 , 2 , … , v - 1 ) \{ \pm u \hat{} ( - 1 ) n mod N \} , v ∈ \{ Δ\_F , Δ\_F + 1 , … , min ⊤ ( τ ∈ \{ \pm 1 , \pm 2 , … , \pm ( Δ\_T - 1 ) \} ) \{ u τ mod N \} \} \} ,$$
wherein [symbol] represents the set, wherein N represents the sequence length, wherein u represents the root sequence number, wherein Δ_{T} represents the maximum round-trip time, wherein Δ_{F} represents the maximum Doppler frequency shift, wherein
$$〈 {τ}_{i}^{F} , {v}_{i}^{F} 〉$$
represents an i^{th} Doppler-domain cyclic shift reference point, wherein a value range of i is 1≤i≤| [symbol] |, wherein a first operator (·)⁻¹ represents a multiplicative inverse, and wherein a second operator |·| represents a cardinality of the set.

7. The method of claim 4, wherein a first quantity of second cyclic shifts corresponding to the cyclic shift reference point satisfies:
$${Ω}_{*}^{†} = max \{ {Ω}_{1}^{T} , {Ω}_{2}^{T} , … {Ω}_{\vert {𝒮}_{T} \vert}^{T} , {Ω}_{1}^{F} , {Ω}_{2}^{F} , … {Ω}_{\vert {𝒮}_{F} \vert}^{F} \} ,$$
wherein
$${Ω}_{*}^{†}$$
represents the first quantity, wherein
$$〈 {τ}_{*}^{†} , {v}_{*}^{†} 〉$$
represents the cyclic shift reference point, wherein
$${Ω}_{1}^{T} , {Ω}_{2}^{T} , … {Ω}_{\vert {𝒮}_{T} \vert}^{T}$$
represents a second quantity of third cyclic shifts corresponding to the delay-domain cyclic shift reference point, and wherein
$${Ω}_{1}^{F} , {Ω}_{2}^{F} , … , {Ω}_{\vert {𝒮}_{F} \vert}^{F}$$
represents a third quantity of fourth cyclic shifts corresponding to the Doppler-domain cyclic shift reference point.

8. The method of claim 4, wherein a first quantity of second cyclic shifts corresponding to the delay-domain cyclic shift reference point satisfies:
$${Ω}_{i}^{T} = {k}_{i}^{T} \cdot {l}_{i}^{T} + {\overline{k}}_{i}^{T} \cdot {\overline{l}}_{i}^{T} + {\overline{\overline{k}}}_{i}^{T} \cdot {\overline{\overline{l}}}_{i}^{T} ,$$
wherein
$${Ω}_{i}^{T}$$
represents the first quantity, wherein
$${k}_{i}^{T}$$
represents a second quantity of delay-domain complete cyclic shifts,
$${l}_{i}^{T}$$
represents a third quantity of Doppler-domain complete cyclic shifts, wherein
$${\overline{k}}_{i}^{T}$$
represents a fourth quantity of delay-domain near-end residual cyclic shifts, wherein
$${\overline{l}}_{i}^{T}$$
represents a fifth quantity of Doppler-domain near-end residual cyclic shifts, wherein
$${\overline{\overline{k}}}_{i}^{T}$$
represents a sixth quantity of delay-domain far-end residual cyclic shifts, wherein
$${\overline{\overline{l}}}_{i}^{T}$$
represents a seventh quantity of Doppler-domain far-end residual cyclic shifts, and wherein a value range of i is 1≤i≤| [symbol] |.

9. The method of claim 4, wherein a first quantity of second cyclic shifts corresponding to the Doppler-domain cyclic shift reference point satisfies:
$${Ω}_{i}^{F} = {l}_{i}^{F} \cdot {k}_{i}^{F} + {\overline{l}}_{i}^{F} \cdot {\overline{k}}_{i}^{F} + {\overline{\overline{l}}}_{i}^{F} \cdot {\overline{\overline{k}}}_{i}^{F} ,$$
wherein
$${Ω}_{i}^{F}$$
represents the first quantity, wherein
$${l}_{i}^{F}$$
represents a second quantity of Doppler-domain complete cyclic shifts, wherein
$${k}_{i}^{F}$$
represents a third quantity of delay-domain complete cyclic shifts, wherein
$${\overline{l}}_{i}^{F}$$
represents a fourth quantity of Doppler-domain near-end residual cyclic shifts, wherein
$${\overline{k}}_{i}^{F}$$
represents a fifth quantity of delay-domain near-end residual cyclic shifts, wherein
$${\overline{\overline{l}}}_{i}^{F}$$
represents a sixth quantity of Doppler-domain far-end residual cyclic shifts, wherein
$${\overline{\overline{k}}}_{i}^{F}$$
represents a seventh quantity of delay-domain far-end residual cyclic shifts, and wherein a value range of i is 1≤i≤| [symbol] |.

10. The method of claim 1, further comprising:
determining a first sequence from a sequence set, wherein the sequence set comprises second cyclic shift sequences of one or more second root sequences; and
outputting the first sequence.

11. An apparatus, comprising:
a memory configured to store computer-executable instructions; and
at least one processor coupled to the memory and configured to execute the computer-executable instructions to cause the apparatus to:
determine a first cyclic shift of a first root sequence, wherein the first cyclic shift is associated with a sequence length of the first root sequence, a root sequence number, a maximum round-trip time, and a maximum Doppler frequency shift; and
determine, based on the first cyclic shift, a first cyclic shift sequence,
wherein a first ambiguity function of the first cyclic shift sequence is equal to zero within a range of the maximum round-trip time and the maximum Doppler frequency shift.

12. The apparatus of claim 11, wherein the at least one processors is further configured to execute the computer-executable instructions to cause the apparatus to further determine the first cyclic shift sequence by satisfying:
$${s}_{u , v} ( n ) = {e}^{- j π u ( n + {C}_{v} ) ( n + {C}_{v} + 1 ) / N} ,$$
wherein s_{u,v}(n) represents the first cyclic shift sequence, wherein Cᵥ represents the first cyclic shift, wherein N represents the sequence length, wherein N is a prime number, wherein u represents the root sequence number, wherein a first value range of u is 1≤u≤N−1, wherein n represents a symbol index of the first cyclic shift sequence, wherein a second value range of n is 0≤n≤N−1, and wherein v represents an index of the first cyclic shift.

13. The apparatus of claim 11, wherein second ambiguity functions of a second cyclic shift sequence and a third cyclic shift sequence are equal to zero within the range and satisfy:
$$A ( τ , v ) = {\sum }_{n = 0}^{N - 1} {s}_{u , {v}_{1}} ( n ) {s}_{u , {v}_{2}}^{*} ( n - τ ) {e}^{j 2 π n v / N} = \{ \begin{matrix}N , & {v}_{1} = {v}_{2} , τ = 0 , v = 0 \\ 0 , & ( {v}_{1} \neq {v}_{2} ) ∨ ( τ \neq 0 ) ∨ ( v \neq 0 )\end{matrix} ,$$
wherein A(τ, v) represents the second ambiguity functions, wherein s_{u,v}_{₁}(n) represents the second cyclic shift sequence, wherein s_{u,v}_{₂}(n) represents the third cyclic shift sequence, wherein Δ_{T} represents the maximum round-trip time, wherein Δ_{F} represents the maximum Doppler frequency shift, wherein N represents the sequence length, wherein u represents the root sequence number, wherein v₁ and v₂ represent indexes of second cyclic shifts of the first root sequence, wherein τ represents a delay coordinate of the first ambiguity function, wherein a first value range of τ is 0≤τ≤Δ_{T}−1, wherein v represents a Doppler coordinate of the first ambiguity function, wherein a second value range of v is 0≤τ≤Δ_{F}−1, wherein a first operator (·)* represents a complex conjugate, and wherein a second operator V represents conditional OR.

14. The apparatus of claim 11, wherein the at least one processor is further configured to execute the computer-executable instructions to cause the apparatus to further determine the first cyclic shift by:
determining, based on a delay-domain cyclic shift reference point and a Doppler-domain cyclic shift reference point, a cyclic shift reference point of the first root sequence; and
determining, based on the cyclic shift reference point, the first cyclic shift.

15. The apparatus of claim 14, wherein a set comprising coordinates of the delay-domain cyclic shift reference point satisfies:
$$𝒮\_T {=}^{Δ} \{ 〈 τ\_ {1}^{⋀} T , v\_ {1}^{⋀} T 〉 , 〈 τ\_ {2}^{⋀} T , v\_ {2}^{⋀} T 〉 , … , 〈 τ\_ \vert 𝒮\_T {\vert}^{⋀} T , v\_ \vert 𝒮\_T {\vert}^{⋀} T 〉 \} = \{ 〈 τ , u τ mod N 〉 \vert min \{ \pm uτmod N \} < {min}_{⊤} ( n = 1 , 2 , … , τ - 1 ) \{ \pm unmod N \} , τ ∈ \{ Δ\_T , Δ\_T + 1 , … , {min}_{⊤} ( v ∈ \{ \pm 1 , \pm 2 , … , \pm ( Δ\_F - 1 ) \} ) \{ {u}^{⋀} ( - 1 ) v mod N \} \} \} ,$$
wherein [symbol] represents the set, wherein N represents the sequence length, wherein u represents the root sequence number, wherein Δ_{T} represents the maximum round-trip time, wherein Δ_{F} represents the maximum Doppler frequency shift, wherein
$$( {τ}_{i}^{T} , {v}_{i}^{T} 〉$$
represents coordinates of an i^{th} delay-domain cyclic shift reference point, wherein a value range of i is 1≤i≤| [symbol] |, wherein a first operator (·)⁻¹ represents a multiplicative inverse, and wherein a second operator |·| represents a cardinality of the set.

16. The apparatus of claim 14, wherein a set comprising coordinates of the Doppler-domain cyclic shift reference point satisfies:
$$𝒮\_F {=}^{Δ} \{ 〈 τ\_ {1}^{⋀} F , v\_ {1}^{⋀} F 〉 , 〈 τ\_ {2}^{⋀} F , v\_ {2}^{⋀} F 〉 , … , 〈 τ\_ \vert 𝒮\_F {\vert}^{⋀} F , v\_ \vert 𝒮\_F {\vert}^{⋀} F 〉 \} = \{ 〈 {u}^{⋀} ( - 1 ) v mod N , v 〉 \vert min \{ \pm {u}^{⋀} ( - 1 ) v mod N \} < {min}_{⊤} ( n = 1 , 2 , … , v - \{ \pm {u}^{⋀} ( - 1 ) n mod N \} , v ∈ \{ Δ\_F , Δ\_F + 1 , … , {min}_{⊤} ( τ ∈ \{ \pm 1 , \pm 2 , … , \pm ( Δ\_T - 1 ) \} ) \{ u τ mod N \} \} \} ,$$
wherein [symbol] represents the set, wherein N represents the sequence length, wherein u represents the root sequence number, wherein Δ_{T} represents the maximum round-trip time, wherein Δ_{F} represents the maximum Doppler frequency shift, wherein
$$( {τ}_{i}^{F} , {v}_{i}^{F} 〉$$
represents an i^{th} Doppler-domain cyclic shift reference point, wherein a value range of i is 1≤i≤| [symbol] |, wherein a first operator (·)⁻¹ represents a multiplicative inverse, and wherein a second operator |·| represents a cardinality of the set.

17. The apparatus of claim 14, wherein a first quantity of second cyclic shifts corresponding to the cyclic shift reference point satisfies:
$${Ω}_{⋆}^{†} = max \{ {Ω}_{1}^{T} , {Ω}_{2}^{T} , … {Ω}_{\vert {𝒮}_{T} \vert}^{T} , {Ω}_{1}^{F} , {Ω}_{2}^{F} , … , {Ω}_{\vert {𝒮}_{F} \vert}^{F} \} ,$$
wherein
$${Ω}_{*}^{†}$$
represents the first quantity, wherein
$$〈 {τ}_{*}^{†} , {v}_{*}^{†} 〉$$
represents the cyclic shift reference point, wherein
$${Ω}_{1}^{T} , {Ω}_{2}^{T} , … {Ω}_{\vert {𝒮}_{T} \vert}^{T}$$
represents a second quantity of third cyclic shifts corresponding to the delay-domain cyclic shift reference point, and wherein
$${Ω}_{1}^{F} , {Ω}_{2}^{F} , … , {Ω}_{\vert {𝒮}_{F} \vert}^{F}$$
represents a third quantity of fourth cyclic shifts corresponding to the Doppler-domain cyclic shift reference point.

18. The apparatus of claim 14, wherein a first quantity of second cyclic shifts corresponding to the delay-domain cyclic shift reference point satisfies:
$${Ω}_{i}^{T} = {k}_{i}^{T} \cdot {l}_{i}^{T} + {\overline{k}}_{i}^{T} \cdot {\overline{l}}_{i}^{T} + {\overline{\overline{k}}}_{i}^{T} \cdot {\overline{\overline{l}}}_{i}^{T} ,$$
wherein
$${Ω}_{i}^{T}$$
represents the first quantity, wherein
$${k}_{i}^{T}$$
represents a second quantity of delay-domain complete cyclic shifts, wherein
$${l}_{i}^{T}$$
represents a third quantity of Doppler-domain complete cyclic shifts, wherein
$${\overline{k}}_{i}^{T}$$
represents a fourth quantity or delay-domain near-end residual cyclic shifts, wherein
$${\overline{l}}_{i}^{T}$$
represents a fifth quantity of Doppler-domain near-end residual cyclic shifts, wherein
$${{k}^{=}}_{i}^{T}$$
represents a sixth quantity of delay-domain far-end residual cyclic shifts, wherein
$${{l}^{=}}_{i}^{T}$$
represents a seventh quantity of Doppler-domain far-end residual cyclic shifts, and wherein a value range of i is 1≤i≤| [symbol] |.

19. The apparatus of claim 14, wherein a first quantity of second cyclic shifts corresponding to the Doppler-domain cyclic shift reference point satisfies:
$${Ω}_{i}^{F} = {l}_{i}^{F} \cdot {k}_{i}^{F} + {\overline{l}}_{i}^{F} \cdot {\overline{k}}_{i}^{F} + {{l}^{=}}_{i}^{F} \cdot {{k}^{=}}_{i}^{F} ,$$
wherein
$${Ω}_{i}^{F}$$
represents the first quantity, wherein
$${l}_{i}^{F}$$
represents a second quantity of Doppler-domain complete cyclic shifts, wherein
$${k}_{i}^{F}$$
represents a third quantity of delay-domain complete cyclic shifts, wherein
$${\overline{l}}_{i}^{F}$$
represents a fourth quantity of Doppler-domain near-end residual cyclic shifts, wherein
$${\overline{k}}_{i}^{F}$$
represents a quantity of delay-domain near-end residual cyclic shifts, wherein
$${{l}^{=}}_{i}^{F}$$
represents a sixth quantity of Doppler-domain far-end residual cyclic shifts, wherein
$${{k}^{=}}_{i}^{F}$$
represents a seventh quantity of delay-domain far-end residual cyclic shifts, and wherein a value range of i is 1≤i≤| [symbol] |.

20. The apparatus of claim 11, wherein the at least one processor is further configured to execute the computer-executable instructions to cause the apparatus to:
determine a first sequence from a sequence set, wherein the sequence set comprises second cyclic shift sequences of one or more second root sequences; and
output the first sequence.
